(19) United States
(12) Patent Application Publication
(10) Pub. No.: US 2014/0079368 A1
(43) Pub. Date: Mar. 20, 2014

(54) DISPLAY DEVICE AND TRANSMISSION DEVICE

(71) Applicant: Panasonic Corporation, Osaka (JP)

(72) Inventors: Taiji Sasaki, Osaka (JP); Toshihiko Munetsugu, Osaka (JP); Yoshimi Nishii, Kyoto (JP); Yuka Ozawa, Osaka (JP); Takuji Hiramoto, Osaka (JP); Yoshihiro Ujiie, Osaka (JP); Tomoki Ogawa, Osaka (JP)

(73) Assignee: Panasonic Corporation, Osaka (JP)

(21) Appl. No.: 14/115,967

(22) PCT Filed: Mar. 8, 2013
(86) PCT No.: PCT/JP2013/001538

§ 371 Date: Nov. 6, 2013

Related U.S. Application Data
(60) Provisional application No. 61/609,492, filed on Mar. 12, 2012.

(51) Int. Cl. H04N 5/073

(52) U.S. Cl. CPC H04N 5/0736
USPC 386/207

(57) ABSTRACT

A display device comprising: a reception unit; a display unit; a storage unit; and an acquisition unit. The reception unit receives a stream containing a plurality of video frames and first display timing information specifying a display timing of each video frame. The display unit displays each video frame at a corresponding display timing specified by the first display timing information. The storage unit stores an image and second display timing information specifying a display timing of the image. The acquisition unit acquires correction information specifying a correction amount for correcting the display timing of the image and thereby enabling the image to be displayed in synchronization with the video frames displayed by the display unit. The display unit further displays the image at a corrected display timing determined by correcting the display timing of the image by using the correction amount specified by the correction information.

### TECHNICAL FIELD

The present invention relates to a technology for playing back broadcast content and content accompanying the broadcast content in synchronization.

### BACKGROUND ART

Conventional technology provides a display device that receives video transmitted by broadcast waves (hereinafter referred to as “broadcast video”) and video transmitted by a communication network such as an internet line (hereinafter referred to as “communication video”) and displays such videos in synchronization.

For example, Non-Patent Literature 1 discloses the Hybridcast™ system, which includes a broadcasting station that transmits broadcast video and a communication service providing station that transmits communication video. The broadcasting station transmits the broadcast video while appending, to each video frame constituting the broadcast video, display timing information (for example, a presentation time stamp (PTS)) indicating a timing at which the video frame is to be displayed so that the broadcast video is displayed, in synchronization with the communication video, at the timing intended by the video content producer. The communication service providing station transmits the communication video while appending, to each video frame constituting the communication video, display timing information so that the communication video is displayed, in synchronization with the broadcast video, at the timing intended by the video content producer. A display device is also included in the Hybridcast™ system. The display device receives the broadcast video and the communication video and displays each video frame constituting the broadcast video and each video frame constituting the communication video at the timing indicated by the display timing information appended thereto.

Accordingly, the display device is able to display the broadcast video and the communication video in synchronization at the timing intended by the video content producer.

### CITATION LIST

### Non-Patent Literature

[Non-Patent Literature 1]

NHK STRL R&D, No. 124, “Hybridcast™ No Gaiyou To Gijyutsu (Overview and Technology of Hybridcast™)”

### SUMMARY OF INVENTION

### Technical Problem

Meanwhile, there are cases where broadcast times of programs broadcasted by broadcasting stations are suddenly changed. Broadcast times of programs may be changed when, for example, a short notice decision is made to broadcast a breaking news program. In such a case, broadcast times of programs to be broadcasted after the breaking news program are changed.

When a broadcast time of a given program is changed in such a case as described above, broadcast video corresponding to the given program needs to be displayed at a display timing differing from the display timing that was initially intended by the video content producer. Accordingly, it turns out that each video frame constituting the broadcast video is appended thereto display timing information differing from the display timing information that was to be appended according to the initial plan.

In the following, a case is considered where a broadcast time of a given program is changed after a display device receives and stores therein communication video corresponding to the given program. In such a case, even if the display device were to display each video frame constituting broadcast video corresponding to the given program and each video frame constituting the communication video at the respective timings indicated by the display timing information appended thereto, the broadcast video and the communication video would not be displayed in synchronization at the timing intended by the video content producer.

In view of such a problem, the present invention provides a display device that is capable of displaying broadcast video and communication video in synchronization at the timing specified by the video content producer, even when a broadcast time of a program corresponding to the videos is changed after the display device receives and stores therein the communication video.

### Solution to the Problems

One aspect of the present invention is a display device that receives a stream containing a plurality of video frames, separately acquires and stores therein an image, and displays the received stream and the acquired image in synchronization. The display device comprises: a reception unit that receives a stream containing a plurality of video frames and first display timing information, the first display timing information specifying a display timing of each of the video frames; a display unit that displays each of the video frames at a corresponding display timing specified by the first display timing information; a storage unit that stores an image and second display timing information specifying a display timing of the image; and an acquisition unit that acquires correction information specifying a correction amount for correcting the display timing of the image and thereby enabling the image to be displayed in synchronization with the video frames displayed by the display unit. The display unit displays the image at a corrected display timing determined by correcting the display timing of the image by using the correction amount specified by the correction information, whereby the image is displayed in synchronization with the video frames.

### Advantageous Effects of the Invention

The display device pertaining to the present invention, having the structure as described above, is capable of displaying broadcast video and communication video in synchronization at the timing specified by the video content producer, even when a broadcast time of a program corresponding to the videos is changed after the display device receives and stores therein the communication video.

### BRIEF DESCRIPTION OF THE DRAWINGS

FIG. 1 is a conceptual diagram of a broadcast system 100.

FIG. 2 is a schematic diagram illustrating overall structures of a broadcasting station 120 and a communication service providing station 130.

FIG. 3 is a schematic diagram illustrating one example of videos handled by the broadcasting station 120 and the communication service providing station 130.

FIG. 4A is an exterior diagram of a display device 110, FIG. 4B is a schematic diagram illustrating a state where the display device 110 is displaying broadcast video on a screen, and FIG. 4C is a schematic diagram illustrating a state where the display device 110 is displaying broadcast video and communication video in synchronization on the screen so as to be superimposed one on top of the other.

FIG. 5 is a diagram illustrating a structure of the display device 110.

FIG. 6 is a diagram illustrating a structure of a primary video decoding unit.

FIG. 7A is a schematic diagram illustrating a state where streams are buffered, and FIG. 7B is a diagram illustrating structures of a first GOP information table and a second GOP information table.

FIG. 8 is a timing chart.

FIG. 9 is a flowchart illustrating output start processing.

FIG. 10 is a diagram illustrating a structure of a first modified primary video decoding unit.

FIG. 11 is a diagram illustrating a structure of a second modified primary video decoding unit.

FIG. 12 is a diagram illustrating a structure of a third modified primary video decoding unit.

FIG. 13A is a timing chart of TS packet sequences before double-rating, FIG. 13B is a timing chart of TS packet sequences after the double-rating, and FIG. 13C is a timing chart of a TS packet sequence of a synthesized stream.

FIG. 14 is a diagram illustrating a structure of a fourth modified primary video decoding unit.

FIG. 15 is a timing chart.

FIG. 16 is a diagram illustrating a structure of a fifth modified primary video decoding unit.

FIG. 17A is a diagram illustrating a data structure of CG image data, and FIG. 17B is a timing chart.

FIG. 18 is a diagram illustrating a structure of a sixth modified primary video decoding unit.

FIG. 19 is a diagram illustrating structures of a modified first GOP information table and a modified second GOP information table.

FIG. 20 is a timing chart.

FIG. 21 is a diagram illustrating a structure of a converter 2100.

FIG. 22 is a timing chart.

FIG. 23 is a diagram illustrating a structure of another primary video decoding unit.

FIG. 24 is a timing chart.

FIG. 25 is a timing chart.

FIG. 26 is a timing chart.

FIG. 28 is a list of APIs of a synchronized playback control module.

FIG. 28 is an example of a script in HTML5 for content extension.

FIG. 29 is an example of a script in HTML5 for content extension.

FIG. 30 is an example of a script in HTML5 for content extension.

FIG. 31 is a diagram illustrating a structure of another primary video decoding unit.

FIG. 32 is a diagram illustrating a structure of a digital stream in the MPEG-2 TS format.

FIG. 33 is a diagram illustrating a hierarchical structure of a video stream.

FIG. 34 is a diagram illustrating structures of access units.

FIG. 35 is a schematic diagram indicating how a video stream is stored in an ES packet sequence.

FIG. 36 is a diagram illustrating a data structure of TS packets.

FIG. 37 is a diagram illustrating a data structure of a PMT.

FIG. 38 is a diagram illustrating a reference structure between pictures.

FIG. 39 is a diagram illustrating a structure of a TTS stream.

FIG. 40 is a diagram illustrating a structure of a display device 4000.

### DESCRIPTION OF EMBODIMENTS

### Embodiment

<Overview>

In the following, as one form of implementation of the display device pertaining to the present invention, description is provided on a display device that (i) receives broadcast video transmitted from a broadcasting station via broadcast waves, (ii) receives communication video transmitted from a communication service providing station via an interne line, and (iii) displays the broadcast video and the communication video in synchronization at the timing specified by the video content producer.

The display device receives, from the communication service providing station, a communication stream including the communication video and PTSs (hereinafter referred to as “communication video PTSs”) each indicating a display timing of a corresponding one of video frames constituting the communication video. In addition, the display device receives, from the broadcasting station, a broadcast stream including: the broadcast video; PTSs (hereinafter referred to as “broadcast video PSTs”) each indicating a display timing of a corresponding one of video frames constituting the broadcast video; and system time counter offset (STC_offset) indicating a correction amount to be used for correcting the display timings indicated by the communication video PTSs. The display device displays each video frame constituting the broadcast video at a timing indicated by the corresponding broadcast video PTS. The display device displays each video frame constituting the communication video at a corrected display timing determined by correcting the display timing indicated by the corresponding communication video PTS by using the correction amount indicated by the STC_offset.

In this way, even when for some reason the display timing of each of the video frames constituting the broadcast video that is indicated by the corresponding broadcast video PTS differs from the display timing intended by the video content producer, the display device is able to display the broadcast video and the communication video in synchronization at the timing intended by the video content producer by receiving the STC_offset, which indicates the correction amount with which the difference in timing can be corrected.

In the following, description is provided on the structure of the display device, with reference to the accompanying drawings.

<Structure>

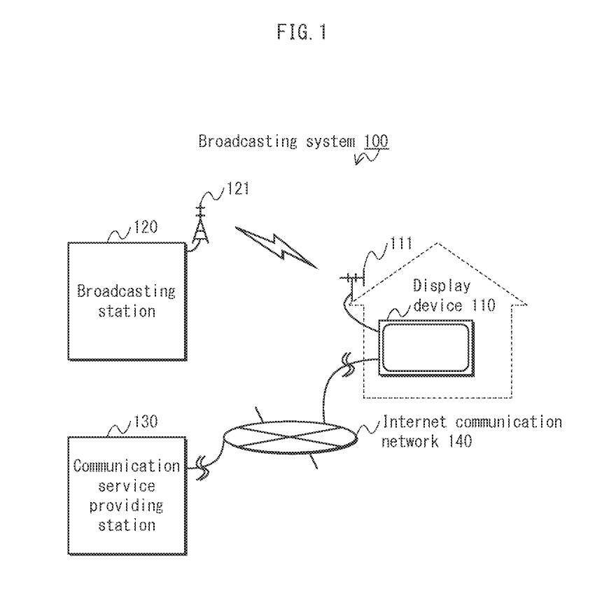

FIG. 1 is a conceptual diagram of a broadcasting system 100 including: a broadcasting station 120; a communication service providing station 130; and a display device 110.

The broadcasting station 120 in FIG. 1 generates a broadcast stream including broadcast video, broadcast video PTSs, and STC_offset indicating a correction amount to be used in correcting display timings indicated by the communication video PTSs. The broadcast stream so generated is in the Moving Picture Experts Group (MPEG)-2 transport stream (TS) format. The broadcasting station 120 transmits the broadcast stream so generated from a broadcast antenna 121 via broadcast waves.

The STC_offset is stored in Program Specific Information (PSI) or Service Information (SI) (hereinafter collectively referred to as “PSI/SI”). For example, the STC_offset may be stored in a program map table (PMT) or an event information table (EIT).

The communication service providing station 130 generates a communication stream including a communication video, which is to be displayed in synchronization with the broadcast video, and communication video PTSs. The communication stream so generated is in the MPEG-2 TS format. The communication service providing station 130 transmits the communication stream so generated to the display device 110 via an internet communication network 140.

The display device 110 receives the broadcast stream transmitted from the broadcasting station 120 at a reception antenna 111 and reconstructs the broadcast video. The display device 110 receives the communication stream transmitted from the communication service providing station 130 via the internet communication network 140 and reconstructs the communication video. Further, the display device 110 displays each video frame constituting the broadcast video so received at a timing indicated by the corresponding broadcast video PTS. The display device 110 also displays each video frame constituting the communication video at a corrected display timing determined by correcting the display timing indicated by the corresponding communication video PTS by using the correction amount indicated by the STC_offset.

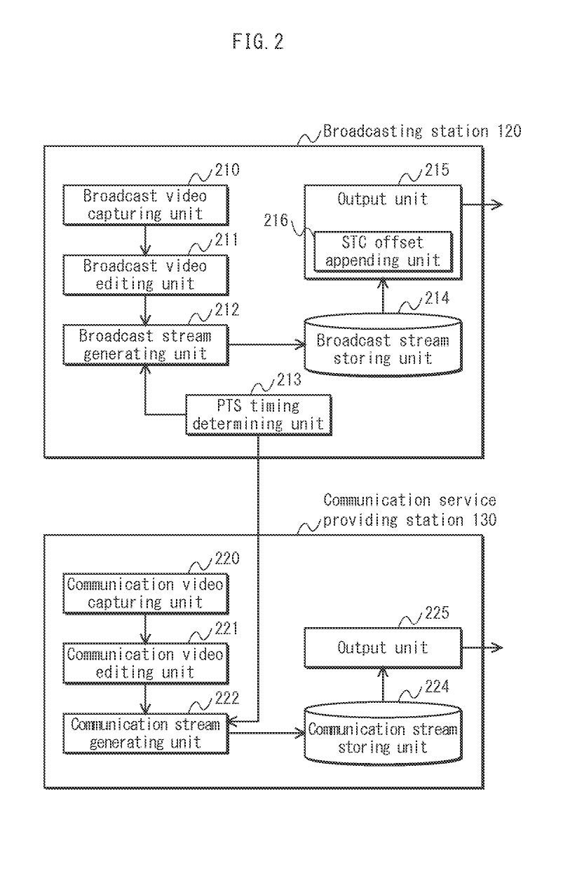

FIG. 2 is a schematic diagram illustrating overall structures of the broadcasting station 120 and the communication service providing station 130.

As illustrated in FIG. 2, the broadcasting station 120 includes: a broadcast video capturing unit 210; a broadcast video editing unit 211; a broadcast stream generating unit 212; a PTS timing determining unit 213; a broadcast stream storing unit 214; and an output unit 215. The output unit 215 includes an STC offset appending unit 216.

As illustrated in FIG. 2, the communication service providing station 130 includes: a communication video capturing unit 220; a communication video editing unit 221; a communication stream generating unit 222; a communication stream storing unit 224; and an output unit 225.

The broadcast video capturing unit 210 includes an image capturing device such as a video camera, and has the function of shooting video and recording audio. The broadcast video capturing unit 210 is not necessarily limited to being in an unmovable state within the broadcasting station 120. That is, the broadcast video image-capturing unit 210 is capable of shooting video and recording audio outside the broadcasting station 120 when necessary.

The broadcast video editing unit 211 includes a computer system equipped with a processor, a memory, etc., and has the function of editing the video and audio captured by the broadcast video capturing unit 210.

The communication video capturing unit 220 includes an image capturing device such as a video camera, and has the function of shooting video and recording audio. The communication video capturing unit 220 is not limited to being in an unmovable state within the communication service providing station 130. That is, the communication video capturing unit 220 is capable of shooting video and recording audio outside the communication service providing station 130 when necessary.

The communication video editing unit 221 includes a computer system equipped with a processor, a memory, etc., and has the function of editing the video and audio captured by the communication video capturing unit 220.

In the following, description is provided on a specific example of the editing performed by the broadcast video editing unit 211 and the communication video editing unit 221, with reference to the accompanying drawings.

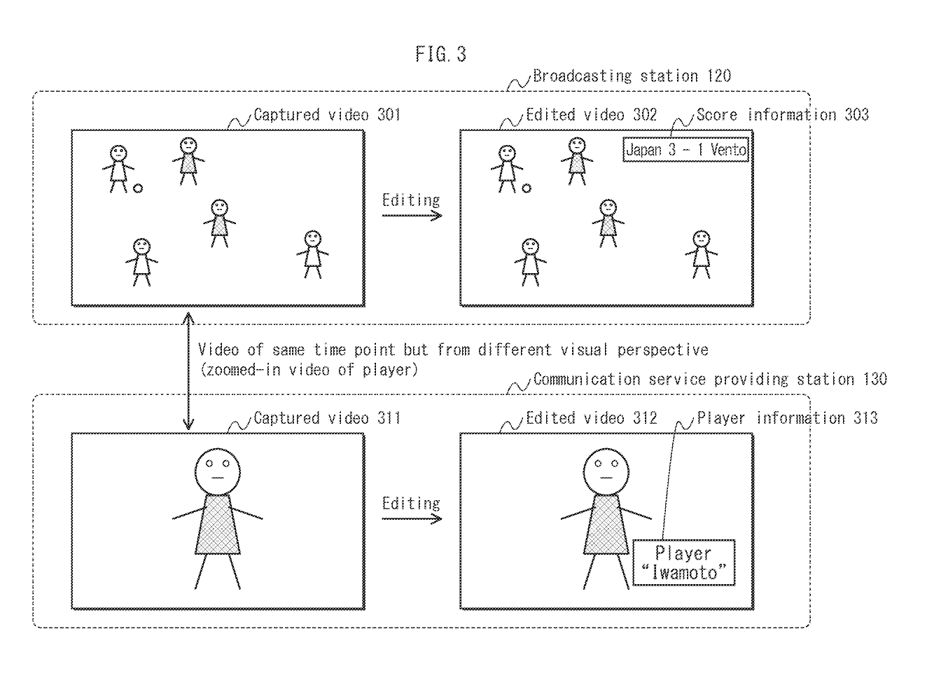

FIG. 3 is a schematic diagram illustrating one example of videos handled by the broadcasting station 120 and the communication service providing station 130.

In the following, description is provided on a case where the broadcast video capturing unit 210 and the communication video capturing unit 220 both capture video for the same soccer match, and further, the broadcast video capturing unit 210 captures video having a relatively wide visual field while the communication video capturing unit 220 captures video from a different visual perspective from that of the video captured by the broadcast video capturing unit 210 (i.e., the communication video capturing unit 220 captures, for example, zoomed-in video of a specific player in the soccer match). Further, description is provided in the following on how the videos captured by the broadcast video capturing unit 210 and the communication video capturing unit 220 are edited, while assuming that a video frame in the video captured by the broadcast video capturing unit 210 and a video frame in the video captured by the communication video capturing unit 220 that have been captured at the same time point are to be displayed at the same time point. Note that in the following, description is provided while focusing on video and while omitting description on audio, so as to avoid the description from becoming unnecessarily complicated and confusing.

As illustrated in FIG. 3, the broadcast video capturing unit 210 captures a captured video 301, which has a relatively wide visual field.

The broadcast video editing unit 211 cuts out a scene to be broadcasted from the captured video 301 captured by the broadcast video capturing unit 210. Further, the broadcast video editing unit 211 overlays graphics such as score information 303 on video images corresponding to the scene that is cut out.

The communication video capturing unit 220 captures a captured video 311. The captured video 311 has a different visual perspective from that of the captured image 301 captured by the broadcast video capturing unit 210.

The communication video editing unit 221 cuts out, from the captured video 311 captured by the communication video capturing unit 220, a scene corresponding to the same time period as the scene cut out by the broadcast video editing unit 211. Further, the communication video editing unit 221 overlays graphics such as player information 313 on video images corresponding to the scene cut out.

Returning to FIG. 2, description on the broadcasting station 120 and the communication service providing station 130 is continued.

The PTS timing determining unit 213 includes a computer system equipped with a processor, a memory, etc., and has the function of determining the value of the PTS to be appended to each of the video frames constituting the video edited by the broadcast video editing unit 211.

The broadcast stream generating unit 212 includes a computer system equipped with a processor, a memory, etc., and has the function of generating a broadcast stream in the MPEG-2 TS format. The broadcast stream generating unit 212 generates the broadcast stream by using the video and the audio edited by the broadcast video editing unit 211 and the PTS values determined by the PTS timing determining unit 213. The broadcast stream so generated includes a video stream, an audio stream, a subtitle stream, and system packets, in a multiplexed state.

For example, the broadcast stream generating unit 212 encodes video in a video codec such as MPEG-2 and MPEG-4 AVC to generate a video stream, and encodes audio in an audio codec such as Audio Code Number 3 (AC3) and Advanced Audio Coding (AAC) to generate an audio stream.

The broadcast stream storing unit 214 includes a storage device such as a hard disc drive, and has the function of storing the broadcast stream generated by the broadcast stream generating unit 212.

The communication stream generating unit 222 includes a computer system equipped with a processor, a memory, etc., and has the function of generating a communication stream in the MPEG-2 TS format. The communication stream generating unit 222 generates the communication stream by using the video and audio edited by the communication video editing unit 221 and the PTS values determined by the PTS timing determining unit 213. The communication stream so generated includes a video stream and an audio stream, in a multiplexed state. Here, the communication stream generating unit 222 generates the communication stream such that each of the video frames constituting the video edited by the communication video editing unit 221 is appended thereto a PTS having the same value as the PTS appended to a corresponding video frame captured at the same time point, among the video frames constituting the video edited by the broadcast video editing unit 211.

For example, the communication stream generating unit 222 encodes video in a video codec such as MPEG-2 and MPEG-4 AVC to generate a video stream, and encodes audio in an audio codec such as AC3 and AAC to generate an audio stream. Thus, the communication stream generating unit 222 performs encoding in a similar manner as the broadcast stream generating unit 212

The communication stream storing unit 224 includes a storage device such as a hard disc drive, and has the function of storing the communication stream generated by the communication stream generating unit 222.

The STC offset appending unit 216 includes a computer system equipped with a processor, a memory, etc., and has an STC offset appending function as described in the following.

In specific, when the broadcast time of the program corresponding to the video stream stored in the broadcast stream storing unit 214 is changed, the STC offset appending function of the STC_offset appending unit 216 includes: (i) calculating a value indicating the difference between the values of the broadcast video PTSs appended to the video frames before the change of the broadcast time and the values of the broadcast video PTSs appended to the video frames after the change of the broadcast time, and (ii) storing the value so calculated, as the STC_offset, to the PSI/SI of the broadcast stream to be newly output. On the other hand, when the broadcast time of the program corresponding to the video stream stored in the broadcast stream storing unit 214 is not changed, the STC offset appending function includes storing, to the PSI/SI of the broadcast stream to be newly output, STC_offset indicating that the value indicating the difference is “0”.

The output unit 215 includes a computer system equipped with a processor, a memory, etc., an output amplifier, and the like, and has the function of modulating the broadcast stream output by the STC offset appending unit 216 in a predetermined format to generate broadcast signals of a predetermined frequency range and transmitting the modulated broadcast signals from the broadcast antenna 121. As already described above, the STC_offset is stored in the PSI/SI of the broadcast stream output by the STC offset appending unit 216.

The output unit 225 includes a computer system equipped with a processor, a memory, etc., and has the function of (i) outputting the communication stream stored in the communication stream storing unit 224 to the display device 110 via the internet communication network 140 and (ii) outputting, to the display device 110 via the internet communication network 140, arrival time counter delay (ATC_delay) designating a delay amount (delay value) to be used when a later-described buffer 542 included in the display device 110 is to delay the communication stream input thereto.

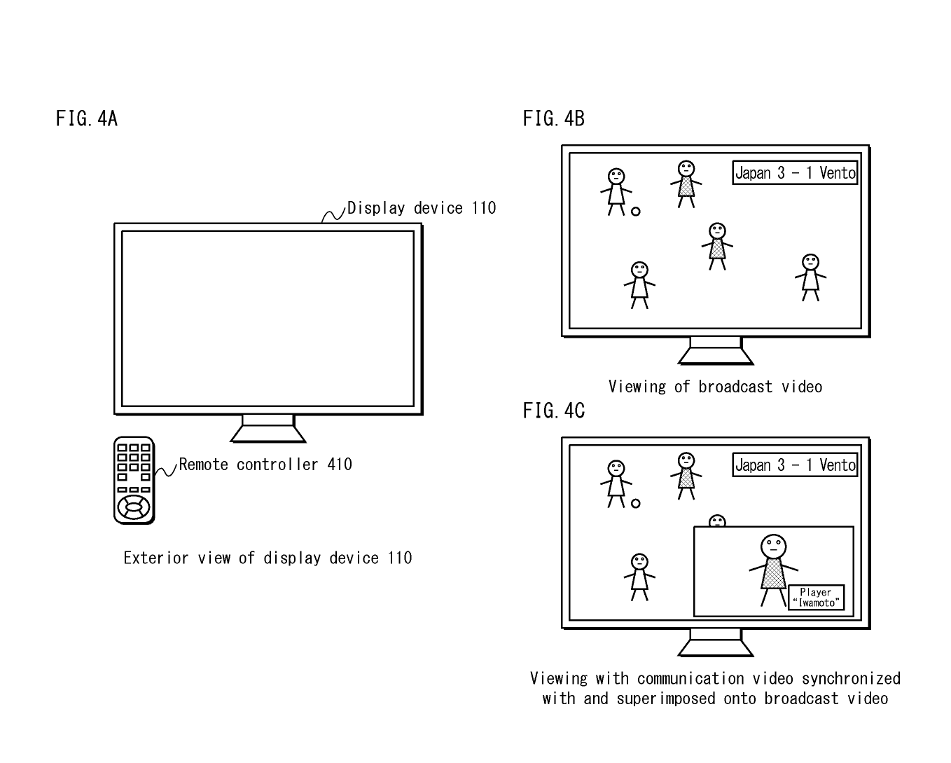

FIG. 4A is an exterior view of the display device 110. FIG. 4B is a schematic diagram illustrating a state where the display device 110 is reconstructing broadcast video from the broadcast stream received and is thereby displaying, on a screen, the reconstructed broadcast video. FIG. 4C is a schematic diagram showing a state where the display device 110 is reconstructing broadcast video and communication video from the broadcast stream and the communication stream received, respectively, and is displaying the reconstructed broadcast video and the reconstructed communication video in synchronization on the screen by superimposing the reconstructed communication video onto the reconstructed broadcast video.

As illustrated in FIG. 4A, the display device 110 is accompanied by a remote controller 410. A user of the display device 110 controls the display device 110 by using the remote controller 410.

As illustrated in FIG. 4C, the display device 110, when displaying broadcast video and communication video in synchronization, displays the communication video as a Picture-In-Picture overlaid on a part of the broadcast video.

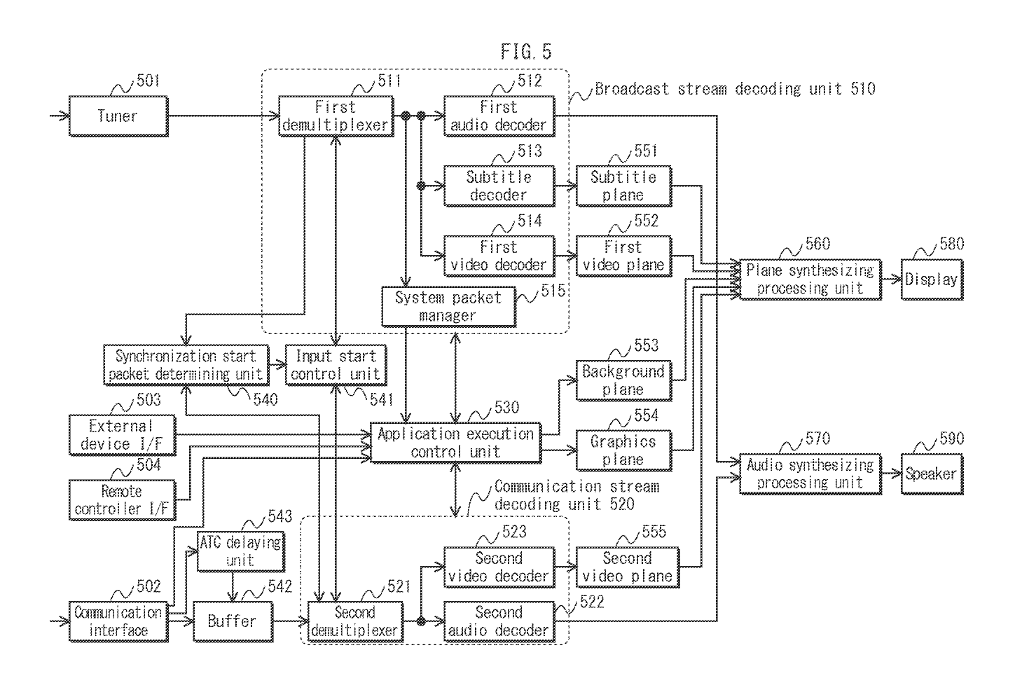

FIG. 5 is a diagram illustrating a structure of the display device 110.

As illustrated in FIG. 5, the display device 110 includes: a tuner 501; a communication interface 502; an external device interface 503; a remote controller interface 504; a broadcast stream decoding unit 510; a communication stream decoding unit 520; an application execution control unit 530; a synchronization start packet determining unit 540; an input start control unit 541; a buffer 542; an ATC delaying unit 543; a subtitle plane 551; a first video plane 552; a background plane 553; a graphics plane 554; a second video plane 555; a plane synthesizing processing unit 560; an audio synthesizing processing unit 570; a display 580; and a speaker 590.

The broadcast stream decoding unit 510 includes: a first demultiplexer 511; a first audio decoder 512; a subtitle decoder 513; a first video decoder 514; and a system packet manager 515. The communication stream decoding unit 520 includes: a second demultiplexer 521; a second video decoder 523; and a second audio decoder 522.

The tuner 501 has the function of receiving the broadcast signals transmitted from the broadcasting station 120 by using the reception antenna 111, demodulating the broadcast signals, and outputting the broadcast stream obtained through the demodulation to the broadcast stream decoding unit 510.

The communication interface 502 includes, for example, a network interface card (NIC) or the like, and has the function of receiving the communication stream output from the communication service providing station 130 from the internet communication network 140 and outputting the communication stream so received to the buffer 542, the function of receiving the ATC_delay output from the communication service providing station 130 and outputting the ATC_delay so received to the ATC delaying unit 543, and the function of obtaining an application to be executed by the application execution control unit 530, computer graphics (CG) image data to be drawn by the application execution control unit 530, and the like from the internet communication network 140 and outputting the application, the CG image data, and the like, to the application execution control unit 530.

The buffer 542 has the function of outputting the communication stream transmitted from the communication interface 502 to the communication stream decoding unit 520. The buffer 542, upon outputting the communication stream to the communication stream decoding unit 520, delays the communication stream by the delay amount designated by the ATC delaying unit 543.

The ATC delaying unit 543 has the function of causing the buffer 542 to delay the output to the communication stream decoding unit 520 of the communication stream transmitted from the communication interface 502 by the delay value designated by the ATC_delay, when the ATC_delay is transmitted from the communication interface 502.

The external device interface 503 includes, for example, a Universal Serial Bus (USB) port, etc., and has the function of receiving signals from external devices connected therewith (for example, a camera, a motion sensor, a USB memory, etc.), and outputting the signals so received to the application execution control unit 530.

The remote controller interface 504 has the function of receiving signals transmitted from the remote controller 410 and outputting the signals so received to the application execution control unit 530.

The first demultiplexer 511 has the function of separating the broadcast stream transmitted from the tuner 501 into a video stream, an audio stream, a subtitle stream, and system packets, and outputting the video stream, the audio stream, the subtitle stream, and the system packets so separated. Specifically, the video stream is output to the first video decoder 514, the audio stream is output to the first audio decoder 512, the subtitle stream is output to the subtitle decoder 513, and the system packets are output to the system packet manager 515.

The second demultiplexer 521 has the function of separating the communication stream transmitted from the buffer 542 into a video stream and an audio stream, and outputting the video stream and the audio stream so separated. Specifically, the video stream is output to the second video decoder 523, and the audio stream is output to the second audio decoder 522.

The first video decoder 514 has the function of decoding the video stream transmitted from the first demultiplexer 511 to generate uncompressed video frames, and outputting each of the video frames so generated to the first video plane 552 at the timing indicated by the PTS associated therewith.

The second video decoder 523 has the function of decoding the video stream transmitted from the second demultiplexer 521 to generate uncompressed video frames, and outputting each of the video frames so generated to the second video plane 555 at the timing indicated by the PTS associated therewith.

The first audio decoder 512 has the function of decoding the audio stream transmitted from the first demultiplexer 511 to generate uncompressed audio frames in the linear pulse code modulation (LPCM) format, and outputting each of the audio frames so generated to the audio synthesizing processing unit 570 at the timing indicated by the PTS associated therewith.

The second audio decoder 522 has the function of decoding the audio stream transmitted from the second demultiplexer 521 to generate uncompressed audio frames in the LPCM format, and outputting each of the audio frames so generated to the audio synthesizing processing unit 570 at the timing indicated by the PTS associated therewith.

The subtitle decoder 513 has the function of decoding the subtitle stream transmitted from the first demultiplexer 511 to generate uncompressed image frames, and outputting each of the image frames so generated to the subtitle plane 551 at the timing indicated by the PTS associated therewith.

The system packet manager 515 has the two functions described in the following.

Data providing function of the system packet manager 515: a function of analyzing the system packets transmitted from the first demultiplexer 511 and providing, in response to requests from the application execution control unit 530, necessary data to the application execution control unit 530.

Here, the data that the system packet manager 515 provides to the application execution control unit 530 includes: program information stored in encoded information type (EIT) packets or the like; stream attribute information stored in program map table (PMT) packets; and information on Broadcast Markup Language (BML) contents provided in Digital Storage Media-Command and Control (DSM-CC) data or the like.

Notifying function of the system packet manager 515: a function of, when the system packets transmitted from the first demultiplexer 511 include a packet including an application execution control signal for the application execution control unit 530 (e.g., an application execution start signal, an application execution termination signal, etc.,), notifying the application execution control unit 530 of the application execution control signal at the timing at which such a packet is received.

The application execution control unit 530 has the function of executing the application obtained by the communication interface 502. For instance, the application execution control unit 530 functions as a web browser when the application contents are described in hypertext markup language (HTML), and the application execution control unit 530 functions as a Java VM when the application contents are described in Java™.

Here, the application obtains, via a broadcast resource access application programming interface (API) and from the system packet manager 515, program information of a broadcast program currently being displayed, stream attribute information, etc. Further, the application, via a playback control API, controls the operation, the termination, etc., of the broadcast stream decoding unit 510 and the communication stream decoding unit 520. In addition, the application, via a graphics drawing API, outputs CG images to the background plane 553 and the graphics plane 554. Further in addition, the application controls how the plane synthesizing processing unit 560 synthesizes planes. The plane synthesizing processing unit 560 synthesizes planes while performing scaling (enlargement, reduction, etc.) of planes, positioning of planes with respect to the video plane, etc. Further, the application obtains data from the external device interface 503 and the remote controller interface 504, and realizes a graphical user interface by changing displayed image content in accordance with user operations.

The subtitle plane 551 is a buffer for storing frames transmitted from the subtitle decoder 513. The first video plane 552 is a buffer for storing frames transmitted from the first video decoder 514. The background plane 553 is a buffer for storing background images transmitted from the application execution control unit 530. The graphics plane 554 is a buffer for storing CG images transmitted from the application execution control unit 530. The second video plane 555 is a buffer for storing frames transmitted from the second video decoder 523.

The plane synthesizing processing unit 560 generates a single image by combining: the image in the subtitle plane 551; the image in the first video plane 552; the image in the background plane 553; the image in the graphics plane 554; and the image in the second video plane 555. The plane synthesizing processing unit 560 further outputs the image so generated to the display 580.

Here, the plane synthesizing processing unit 560 combines the images by overlaying the images stored in the buffers one on top of another in order from those closer to the rearmost side, or that is, in the order of the image in the background plane 553, the image in the first video plane 552, the image in the second video plane 555, the image in the subtitle plane 551, and the image in the graphics plane 554. In addition, the plane synthesizing processing unit 560 performs scaling (enlargement, reduction, etc.) of planes, positioning of planes with respect to the video plane, etc., in accordance with the control performed by the application executed by the application execution control unit 530.

The audio synthesizing processing unit 570 has the function of mixing the audio frames output from the first audio decoder 512 and the audio frames output from the second audio decoder 522 (i.e., overlaying sound on sound), and outputting the result of the mixing to the speaker 590.

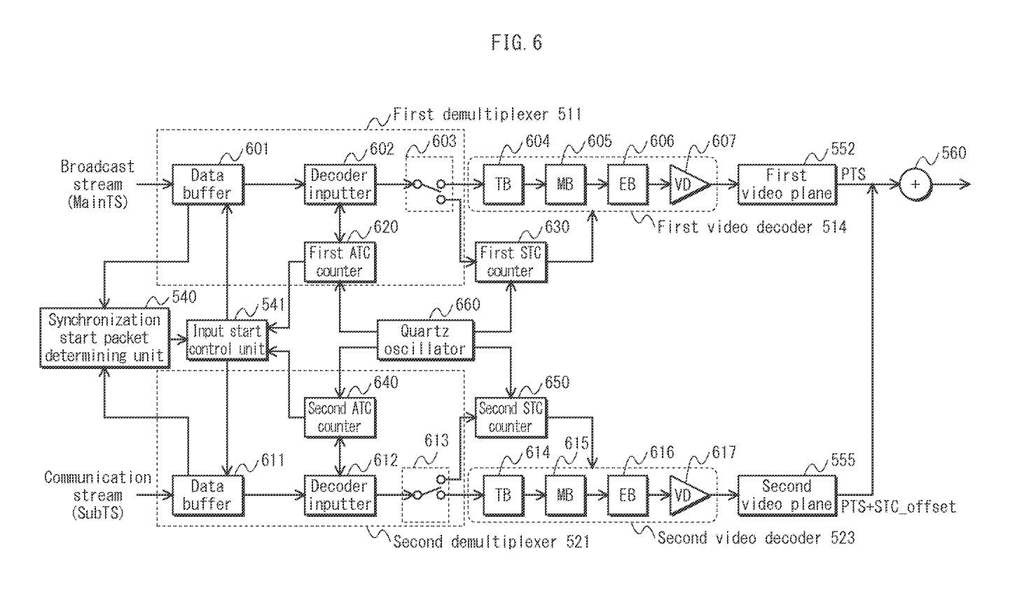

FIG. 6 is a diagram illustrating, in further detail, a structure of a part in FIG. 5 including the first demultiplexer 511, the second demultiplexer 521, the first video decoder 514, the second video decoder 523, the synchronization start packet determining unit 540, and the input start control unit 541 (such part hereinafter referred to as a “primary video decoding unit”).

The first demultiplexer 511 includes: a data buffer 601; a decoder inputter 602; a packet ID (PID) filter 603; and a first ATC counter 620. The second demultiplexer 521 includes: a data buffer 611; a decoder inputter 612; a PID filter 613; and a second ATC counter 640. The first video decoder 514 includes: a TB 604; an MB 605; an EB 606; and a video decoder 607. The second video decoder 523 includes: a TB 614; an MB 615; an EB 616; and a video decoder 617.

In addition, the primary video decoding unit includes a quartz oscillator 660, a first STC counter 630, and a second STC counter 650, although not illustrated in FIG. 5.

The data buffer 601 and the data buffer 611 have similar structures. The same applies to: the decoder inputter 602 and the decoder inputter 612; the PID filter 603 and the PID filter 613; the first ATC counter 620 and the second ATC counter 640; the first STC counter 630 and the second STC counter 650; the TB 604 and the TB 614; the MB 605 and the MB 615; the EB 606 and the EB 616; and the video decoder 607 and the video decoder 617. As such, description is provided on one each of the above-mentioned pairs, or more specifically, the data buffer 601, the decoder inputter 602, the PID filter 603, the first ATC counter 620, the first STC counter 630, the TB 604, the MB 605, the EB 606, and the video decoder 607.

The quartz oscillator 660 is an oscillator that utilizes the piezoelectric effect of quartz and oscillates at a frequency of 27 MHz.

The first ATC counter 620 is a counter that measures time on an ATC time axis by utilizing the oscillation of the quartz oscillator 660. More specifically, the first ATC counter 620 increments a value indicating the time on the ATC time axis at a frequency of 27 MHz.

The first STC counter 630 is a counter that measures time on an STC time axis by utilizing the oscillation of the quartz oscillator 660. More specifically, the first STC counter 630 increments a value indicating the time on the STC time axis at a frequency of 90 MHz. Further, the first STC counter 630, when receiving a program clock reference (PCR) packet output from the PID filter 603, updates the STC time axis at the timing of arrival of the PCR packet by using a PCR value of the PCR packet. Since PCR packets are continuously input to the first STC counter 630 while a stream is being input to the first demultiplexer 511, the first STC counter 630 repeatedly updates the STC value of the STC counter by using the PCR values at the timings of arrival of the PCR packets.

The data buffer 601 is a buffer for temporarily storing a stream, and has the function of outputting the stream stored therein to the decoder inputter 602 at a timing specified by the input start control unit 541. For example, the data buffer 601 includes a dynamic random access memory (DRAM) and a hard disk.

The decoder inputter 602 has the function of inputting, to the PID filter 603, each TS packet constituting the stream stored in the data buffer 601 at a timing at which the TS packet is stored to the data buffer 601. Note that when the stream stored in the data buffer 601 is a timestamped TS (TTS) stream, the decoder inputter 602 inputs a TS packet to the PID filter 603 when an ATS appended to the TS packet matches the value of the first ATC counter 620. Further, note that description is provided in the following while assuming that both the broadcast stream and the communication stream are TTS streams.

The PID filter 603 has the function of, according to a PID appended to the TS packet transmitted from the decoder inputter 602, outputting the TS packet to a corresponding one of the decoders 512, 513, 514, the system packet manager 515, or the first STC counter 630. For example, when a value of a PID appended to a TS packet indicates an audio stream, the PID filter 603 outputs the TS packet to the first audio decoder 512. When a value of a PID appended to a TS packet indicates a video stream, the PID filter 603 outputs the TS packet to the first video decoder 514. Further, when a value of a PID appended to a TS packet indicates a PCR packet, the PID filter 603 outputs the TS packet to the first STC counter 630.

The TB 604 is a buffer for accumulating the TS packets transmitted from the PID filter 603.

The MB 605 is a buffer for temporarily accumulating PES packets when TS packets are output from the TB 604 to the EB 606. More specifically, the MB 605 has the function of removing a TS header and an adaptation field from each TS packet transmitted from the TB 604.

The EB 606 is a buffer for storing pictures in an encoded state, and has the function of removing a PES packet header from each PES packet transmitted from the MB 605.

The video decoder 607 is a decoder that has the function of decoding each encoded picture stored in the EB 606 when a corresponding decoding time (decode time stamp (DTS)) arrives, and outputting each of the decoded pictures to the first video plane 552 when a corresponding display time (PTS) arrives.

The synchronization start packet determining unit 540 has the function of determining packets from which synchronized display is to be started (hereinafter referred to as “synchronization start TS packets”). Specifically, one packet is determined as the synchronization start TS packet from among the packets included in the stream stored in the data buffer 601, and one packet is determined as the synchronization start TS packet from among the packets included in the stream stored in the data buffer 611.

In the following, description is provided on how the synchronization start packet determining unit 540 determines the synchronization start TS packets, with reference to the accompanying drawings.

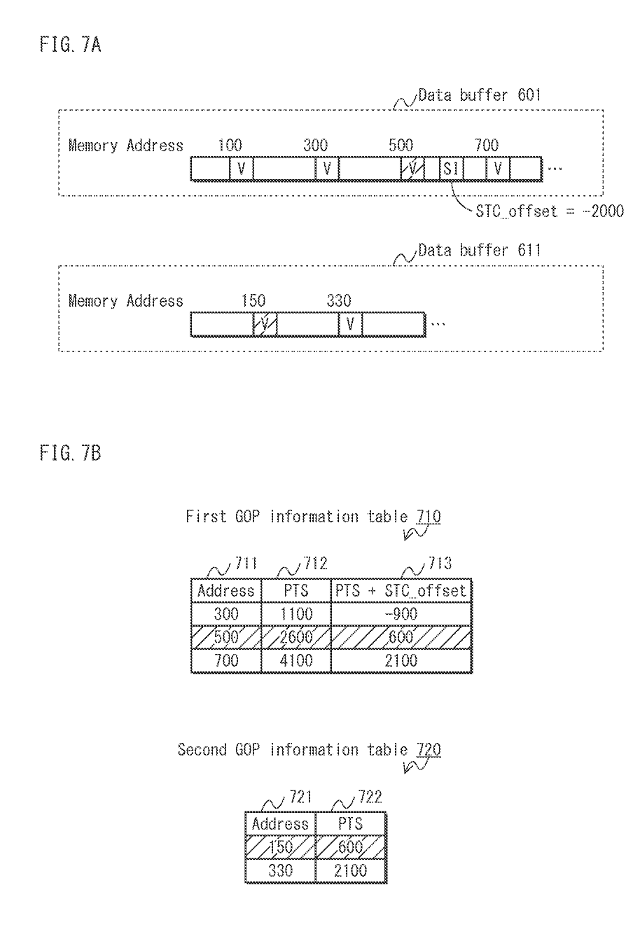

FIG. 7A illustrates a state where a TTS stream of a broadcast stream is buffered in the data buffer 601 and a TTS stream of a communication stream is buffered in the data buffer 611.

In FIG. 7A, the boxes labeled with the alphabet “V” indicate top TS packets of groups of pictures (GOPs) included in the corresponding stream, and the numbers provided above the boxes each indicate a memory address of the top TS packet in the data buffer 601 or the data buffer 611. Note that typically, a top frame of a GOP is an I picture.

The box in FIG. 7A labeled SI indicates SI included in the broadcast stream, and here, description is provided while assuming that the STC_Offset stored in the SI indicates “−2000”.

First of all, the synchronization start packet determining unit 540 obtains, from the broadcast stream stored in the data buffer 601, the memory addresses of the top TS packets of the GOPs included in the broadcast stream, the PTS values of the top TS packets, and the STC_Offset stored in SI, and generates a first GOP information table.

FIG. 7B illustrates a first GOP information table 710, which is one example of the first GOP information table generated by the synchronization start packet determining unit 540.

As illustrated in FIG. 7B, the first GOP information table 710 is a table having an address field 711, a PTS field 712, and a PTS+STC_offset field 713. A value in the address field 711, the corresponding value in the PTS field 712, and the corresponding value in the PTS+STC_offset field 713 are associated with one another.

The values in the address field 711 indicate the memory addresses of the top TS packets of the GOPs, obtained by the synchronization start packet determining unit 540.

The values in the PTS field 712 each indicate a PTS value of the corresponding top TS packet.

The values in the PTS+STC_offset field 713 each indicate a value (hereinafter referred to as a “PTS+STC_offset value”) obtained by adding, to the corresponding PTS value, the STC_offset value obtained by the synchronization start packet determining unit 540.

Following the generation of the first FOP information table, the synchronization start packet determining unit 540 obtains, from the communication stream stored in the data buffer 611, the memory addresses of the top TS packets of the GOPs included in the communication stream and the PTS values of the top TS packets, and generates a second GOP information table.

FIG. 7B illustrates a second GOP information table 720, which is one example of the second GOP information table generated by the synchronization start packet determining unit 540.

As illustrated in FIG. 7B, the second GOP information table 720 is a table having an address field 721 and a PTS field 722. A value in the address field 721 is associated with the corresponding value in the PTS field 722.

The address field 721 is similar to the address field 711 in the first GOP information table 710, and the PTS field 722 is similar to the PTS field 712 in the first GOP information table 710.

After having generated both the first GOP information table 710 and the second GOP information table 720, the synchronization start packet determining unit 540 compares the first GOP information table 710 and the second GOP information table 720 and searches for, among matches between the values in the PTS+STC_offset field 713 and the values in the PTS field 722, a match of the smallest values.

Further, the synchronization start packet determining unit 540 determines, as the synchronization start TS packet of the broadcast stream, a TS packet stored at an address indicated by a value in the address field 711 corresponding to the PTS+STC_offset value included in the match of smallest values. Similarly, the synchronization start packet determining unit 540 determines, as the synchronization start TS packet of the communication stream, a TS packet stored at an address indicated by a value in the address field 721 corresponding to the PTS value included in the match of smallest values.

Specifically, in the example illustrated in FIG. 7B, the TS packet stored at the memory address “500” of the data buffer 601 is determined as the synchronization start TS packet in the broadcast stream, and the TS packet stored in the memory address “150” of the data buffer 611 is determined as the synchronization start TS packet in the communication stream.

The input start control unit 541 has the function of determining a timing for outputting the broadcast stream stored in the data buffer 601 to the decoder inputter 602 and determining a timing for outputting the communication stream stored in the data buffer 611 to the decoder inputter 612.

In the following, description is provided on how the input start control unit 541 determines the above-described output timings, with reference to the accompanying drawings.

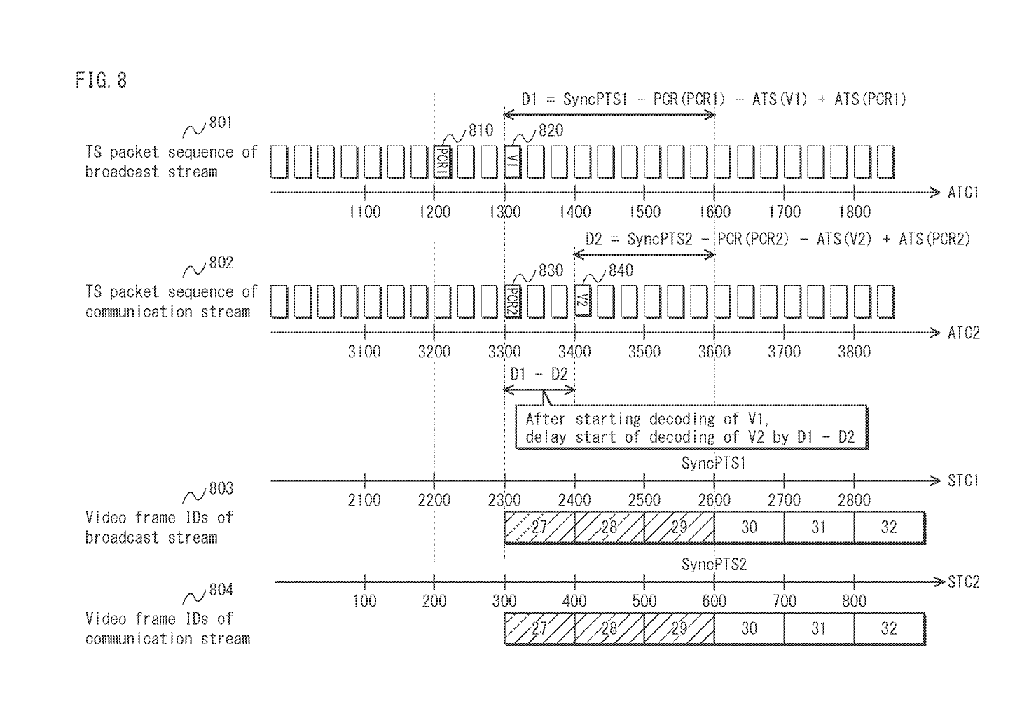

FIG. 8 is a timing chart illustrating the timing at which the decoder inputter 602 outputs a TS packet sequence of the broadcast stream to the PID filter 603, the timing at which the decoder inputter 612 outputs a TS packet sequence of the communication stream to the PID filter 613, and the timing at which video frames obtained by decoding such packet sequences are output to the corresponding video planes.

To prevent description from becoming unnecessarily complex, description is provided in the following while assuming that the broadcast stream and the communication stream are each composed of only a video stream. Further, description is provided in the following while not taking into consideration the actual time units of values such as the later-described ATC1, ATC2, STC1, STC2, actual frame rates, etc. However, when performing actual calculation, the actual time units of values, frame rates, etc., need to be taken into consideration.

In FIG. 8, ATC1 indicates the ATC time axis measured by the first ATC counter 620.

In FIG. 8, a TS packet sequence of the broadcast stream is provided with a reference sign “801”. Further, in FIG. 8, the timings, on the ATC1 time axis, at which TS packets of the TS packet sequence 801 are output from the decoder inputter 602 are indicated. Specifically, the width of each of the boxes along the ATC1 time axis indicates the time period during which the corresponding TS packet is transmitted from the decoder inputter 602 to the PID filter 603.

For example, FIG. 8 indicates that the TS packet 820 is output from the decoder inputter 602 starting at time point “1300” on the ATC1 time axis.

Further, in FIG. 8, the TS packet 820, labeled “V1”, indicates the synchronization start TS packet of the broadcast stream, whereas the TS packet 810, labeled “PCR1”, indicates a PCR packet closest to the synchronization start TS packet of the broadcast stream. Further, the illustration in FIG. 8 is provided under the assumption that a video frame obtained by decoding the TS packet 820 has a frame ID “30”.

Further, in FIG. 8, ATC2 indicates the ATC time axis measured by the second ATC counter 640.

In FIG. 8, a TS packet sequence of the communication stream is provided with a reference sign “802”. Further, in FIG. 8, the timings, on the ATC2 time axis, at which TS packets of the TS packet sequence 802 are output from the decoder inputter 612 are indicated. Specifically, the width of each of the boxes along the ATC2 time axis indicates the time period during which the corresponding TS packet is transmitted from the decoder inputter 612 to the PID filter 613.

For example, FIG. 8 indicates that the TS packet 840 is output from the decoder inputter 612 starting at time point “3400” on the ATC2 time axis.

Further, in FIG. 8, the TS packet 840, labeled “V2”, indicates the synchronization start TS packet of the communication stream, whereas the TS packet 830, labeled “PCR2”, indicates a PCR packet closest to the synchronization start TS packet of the communication stream. Further, the illustration in FIG. 8 is provided under the assumption that a video frame obtained by decoding the TS packet 840 has a frame ID “30”.

In FIG. 8, STC1 indicates the STC time axis measured by the first STC counter 630.

In FIG. 8, a sequence of boxes indicating frame IDs of video frames obtained by decoding the broadcast stream is provided with a reference sign “803”. Further, in FIG. 8, the timings at which the video frames obtained by decoding the TS packet sequence of the broadcast stream are output to the first video plane 552 are indicated.

Specifically, FIG. 8 indicates that the video frame having the frame ID “30”, which is obtained by decoding the TS packet 810, is output to the first video plane 552 at time point “2600” on the STC1 time axis, which corresponds to time point “1600” on the ATC1 time axis.

Further, in FIG. 8, “D1” indicates the length of the time period from when a TS packet is output from the decoder inputter 612 until when a video frame obtained by decoding the TS packet is output to the first video plane 552. FIG. 8 indicates that in this example, the length of the above-described time period is “300” on the ATC1 time axis and “300” on the STC1 time axis. Description concerning the formula based on which D1 is calculated is provided in the following.

In FIG. 8, STC2 indicates the STC time axis measured by the first STC counter 650.

In FIG. 8, a sequence of boxes indicating frame IDs of video frame obtained by decoding the communication stream is provided with a reference sign “804”. Further, in FIG. 8, the timings at which the video frames obtained by decoding the TS packet sequence of the communication stream are output to the second video plane 555 are indicated.

Specifically, FIG. 8 indicates that the video frame having the frame ID “30”, which is obtained by decoding the TS packet 840, is output to the second video plane 555 at time point “6600” on the STC2 time axis, which corresponds to time point “3600” on the ATC2 time axis.

Further, in FIG. 8, “D2” indicates the length of the time period from when a TS packet is output from the decoder inputter 622 until when a video frame obtained by decoding the TS packet is output to the second video plane 555. FIG. 8 indicates that in this example, the length of the above-described time period is “200” on the ATC2 time axis and “200” on the STC2 time axis. Description concerning the formula based on which D2 is calculated is provided in the following.

From FIG. 8, it can be seen that, in order as to ensure that the video frame obtained by decoding the TS packet 820 and the video frame obtained by decoding the TS packet 840 are respectively output to the first video plane 552 and the second video plane 555 at the same time, it is necessary to set the timing at which the TS packet 820 is output from the decoder inputter 602 and the timing at which the TS packet 840 is output from the decoder inputter 612 such that there is a difference of D1−D2 therebetween.

As such, the input start control unit 541 calculates the value of D1−D2, and determines the timing at which the broadcast stream stored in the data buffer 601 is to be output to the decoder inputter 602 and the timing at which the communication stream stored in the data buffer 611 is to be output to the decoder inputter 612. Here, the input start control unit 541 determines the timings at which the streams are to be output to the respective decoder inputters such that there is a difference in time corresponding to the value of D1−D2 so calculated between the timing at which the TS packet 820 is output from the decoder inputter 602 and the timing at which the TS packet 840 is output from the decoder inputter 612, and hence, the synchronization start TS packet of the broadcast stream (the TS packet 820 in FIG. 8) and the synchronization start TS packet of the communication stream (the TS packet 840 in FIG. 8) are respectively output to the first video plane 552 and the second video plane 555 at the same time.

In the following, description is provided on how the value of D1−D2 is calculated.

When denoting a function that returns an ATS value appended to a TS packet X as ATS(X), denoting a function that returns a PCR value appended to a TS packet X as PCR(X), and denoting the timing at which the video frame obtained by decoding the TS packet 820 is output to the first video plane 552 as SyncPTS1, D1 can be expressed as follows.

D1=SyncPTS1?PCR(PCR1)?ATS(V1)+ATS(PCR1) [Math. 1]

Further, when denoting the timing at which the video frame obtained by decoding the TS packet 840 is output to the second video plane 555 as SyncPTS2, D2 can be expressed as follows.

D2=SyncPTS2?PCR(PCR2)?ATS(V2)+ATS(PCR2) [Math. 2]

As such, D1−D2 can be expressed as follows.

D1?D2=SyncPTS1?PCR(PCR1)?ATS(V1)+ATS(PCR1)

[SyncPTS2?PCR(PCR2)−ATS(V2)+ATS(PCR2)] [Math. 3]

Further, the following calculation can be performed by substituting the values indicated in FIG. 8 for the corresponding variables in [Math. 3].

$$\begin{matrix}D 1 ? D 2 = 2600 ? 2200 ? 1300 + 1200 ? \\ [ 600 ? 300 ? 3400 + 3600 ] \\ = 300 ? 200 \\ = 100\end{matrix} \qquad [ Math . 4 ]$$

In the following, description is provided on the operations performed by the display device 110 having the above-described structure, with reference to the accompanying drawings.

<Operations>

The display device 110 is characterized for performing output start processing as described in the following. The output start processing includes: calculating the timing at which the output of a TS packet sequence of the broadcast stream to the decoder inputter 602 is to be started and the timing at which the output of a TS packet sequence of the communication stream to the decoder inputter 612 is to be started; and starting the output of the TS packet sequence of the broadcast stream and the TS packet sequence of the communication stream at the respective timings so calculated. By performing the output start processing, the broadcast video included in the TS packet sequence of the broadcast stream and the communication video included in the TS packet sequence of the communication stream can be displayed in synchronization at the timing intended by the video content producer.

In the following, detailed description is provided on the output start processing.

<Output Start Processing>

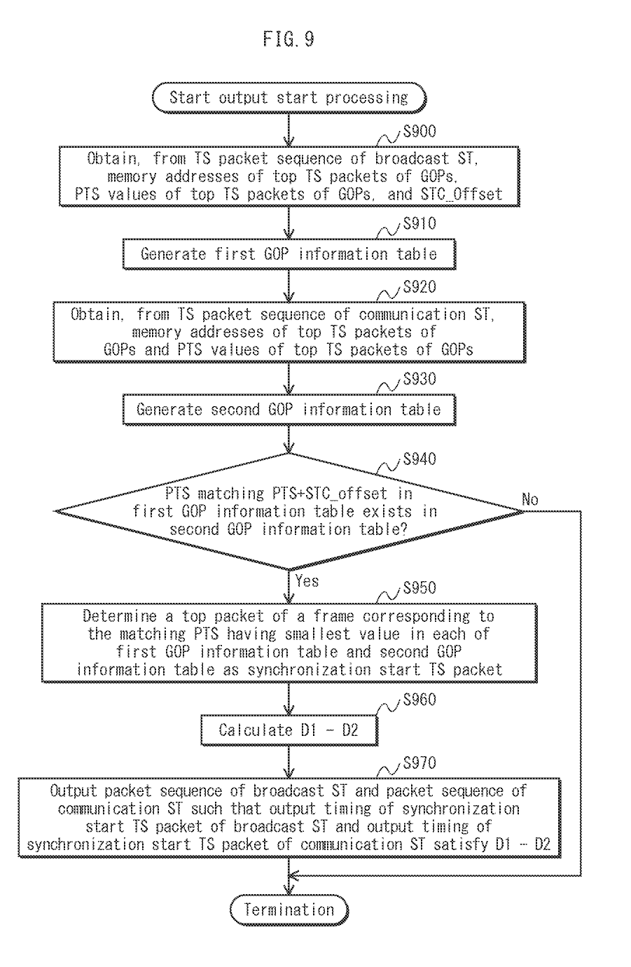

FIG. 9 is a flowchart illustrating the output start processing.

The output start processing is started by the input of a broadcast stream to the data buffer 601 and the input of a communication stream to the data buffer 611 being started.

When the output start processing is started, the synchronization start packet determining unit 540 obtains, from a TS packet sequence corresponding to the broadcast stream already stored in the data buffer 601, the memory addresses of the top TS packets of GOPs, the PTS values of the top TS packets, and the STC_Offset stored in the SI (Step S900), and generates the first GOP information table (Step S910).

Subsequently, the synchronization start packet determining unit 540 obtains, from the TS packet sequence corresponding to the communication stream already stored in the data buffer 611, the memory addresses of the top TS packets of GOPs and the PTS values of the top TS packets (Step S920), and generates the second GOP information table (Step S930).

Then, the synchronization start packet determining unit 540 compares the first GOP information table 710 and the second GOP information table 720 and determines whether or not there is a match between the values in the PTS+STC_offset field 713 and the values in the PTS field 722 (Step S940).

When it is determined that there is at least one match in the processing in Step S940 (Step S940: Yes), the synchronization start packet determining unit 540 searches for, among the at least one matches, a match of the smallest values. Further, the synchronization start packet determining unit 540 determines, as the synchronization start TS packet of the broadcast stream, a TS packet stored at an address indicated by a value in the address field 711 corresponding to the PTS+STC_offset value included in the match of smallest values, and determines, as the synchronization start TS packet of the communication stream, a TS packet stored at an address indicated by a value in the address field 721 corresponding to the PTS value included in the match of smallest values (Step S950).

When the synchronization start TS packets of the broadcast stream and the synchronization start TS packets of the communication stream are calculated, the input start control unit 541 calculates D1−D2 (Step S960). Further, the input start control unit 541 calculates the timing at which the output of a TS packet sequence of the broadcast stream to the decoder inputter 602 is to be started and the timing at which the output of a TS packet sequence of the communication stream to the decoder inputter 612 is to be started such that there is a difference in time of D1−D2 between the output timing of the synchronization start TS packet of the broadcast stream and the output timing of the synchronization start TS packet of the communication stream, and starts the output of the TS packet sequence of the broadcast stream and the TS packet sequence of the communication stream at the respective timings so calculated (Step S970).

The display device 110 terminates the output start processing when the processing in Step S970 is completed or when it is determined that a match between values does not exist in the processing in Step S940 (Step S940: No).

<Observation>

The display device 110 having the above-described structure displays each of the video frames constituting the communication stream at a timing determined by adding the STC_Offset value to the time indicated by the PTS associated with the video frame. Accordingly, a received broadcast video and a received communication video can be displayed in synchronization at the timing intended by the video content producer.

### <Modification 1>

<Overview>

In the following, as one example of implementation of the display device pertaining to the present invention, description is provided on a first modified display device that is yielded by modifying a part of the display device 110 in the above embodiment.

The display device 110 described in the embodiment includes two counters, namely the first ATC counter 620 and the second ATC counter 640, as ATC counters, and includes two counters, namely the first STC counter 630 and the second STC counter 650, as STC counters.

In contrast, the first modified display device in modification 1 is an example of a structure including only one ATC counter and only one STC counter.

In the following, description is provided on the structure of the first modified display device in modification 1 while focusing on the differences thereof with the display device 110 and with reference to the accompanying drawings.

<Structure>

The first modified display device is modified with respect to the display device 110 in the embodiment such that the primary video decoding unit in the display device 110 is replaced by a first modified primary video decoding unit.

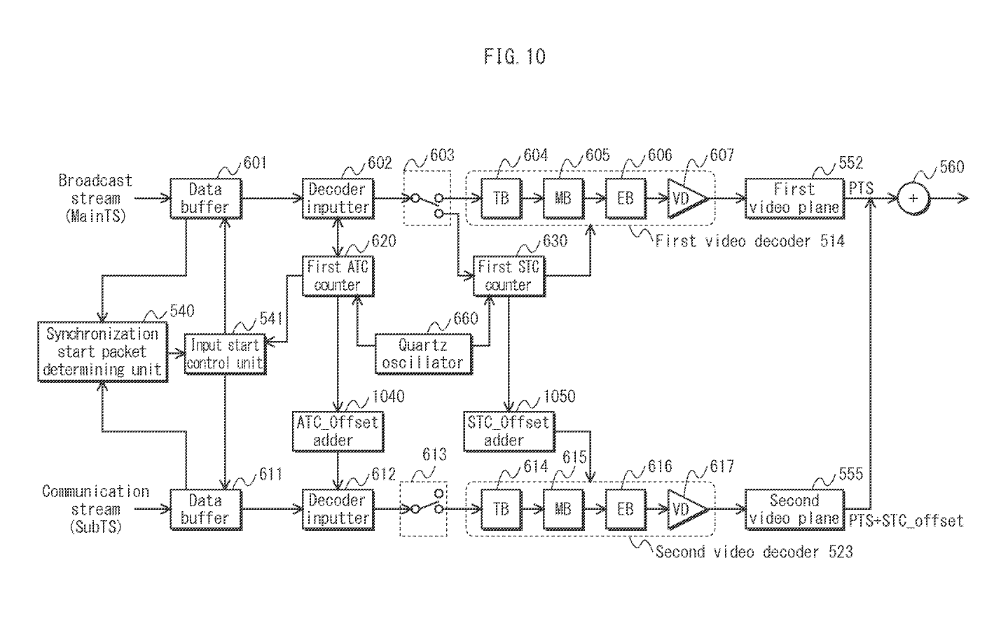

FIG. 10 is a diagram illustrating a structure of the first modified primary video decoding unit.

As illustrated in FIG. 10, the first modified primary video decoding unit is yielded by modifying the primary video decoding unit in the embodiment (refer to FIG. 6) such that the second ATC counter 640 and the second STC counter 650 are deleted and an ATC_Offset adder 1040 and an STC_Offset adder 1050 are added.

The ATC_Offset adder 1040 has the function of calculating ATC_Offset, which is a value indicating the offset of the communication stream with respect to the broadcast stream on the ATC time axis, adding the ATC_Offset so calculated to the ATC time transmitted from the first ATC counter 620, and outputting the result of the addition.

Here, when denoting a function that returns an ATC value corresponding to a value X on the STC time axis of the broadcast stream as ATC1(X), denoting a function that returns an ATC value corresponding to a value X on the time axis of the communication stream as ATC2(X), the ATC_Offset can be expressed as follows.

ATC_Offset=ATC2(SyncPTS2)?ATC1(SyncPTS1) [Math. 5]

This expression can be rewritten as follows.

$$\begin{matrix}ATC\_Offset = [ SyncPTS 2 + ATC 2 ( PCR 2 ) ? \\ PCR ( PCR 2 ) ] ? \\ [ SyncPTS 1 + ATC ( PCR 1 ) ? \\ PCR ( PCR 1 ) ] \\ = STC\_Offset + [ ATC 2 ( PCR 2 ) ? \\ PCR ( PCR 2 ) ] ? \\ [ ATC 1 ( PCR 1 ) ? PCR ( PCR 1 ) ]\end{matrix} \qquad [ Math . 6 ]$$

Further, the following calculation can be performed by substituting the values indicated in FIG. 8 for the corresponding variables in [Math. 6].

$$\begin{matrix}ATC\_Offset = ? 2000+[3300?300]?[1200-2200] \\ = 2000\end{matrix} \qquad [ Math . 7 ]$$

The STC_Offset adder 1050 has the function of adding the STC_Offset included in the broadcast stream to the STC time transmitted from the first STC counter 630, and outputting the result of the addition.

<Observation>

The first modified display device having the above-described structure decodes the broadcast stream along the STC1 time axis and decodes the communication stream along the STC2 time axis, which is calculated by adding the STC_Offset to the STC1 time axis. Accordingly, received broadcast video and received communication video can be displayed in synchronization at the timing intended by the video content producer.

### <Modification 2>

<Overview>

In the following, as one example of implementation of the display device pertaining to the present invention, description is provided on a second modified display device that is yielded by modifying a part of the first modified display device in modification 1.

The first modified display device in modification 1 has a structure corresponding to when the communication stream transmitted by the communication service providing station 130 is a TTS stream in the MPEG-2 TS format.

In contrast, the second modified display device in modification 2 is an example of a structure corresponding to when the communication stream transmitted by the communication service providing station 130 is a PES stream constituted of a PES packet sequence.

In the following, description is provided on the structure of the second modified display device in modification 2 while focusing on the differences thereof with the first modified display device in modification 1 and with reference to the accompanying drawings.

<Structure>

The second modified display device is yielded by modifying the first modified display device in modification 1 such that the first modified primary video decoding unit is replaced with a second modified primary video decoding unit.

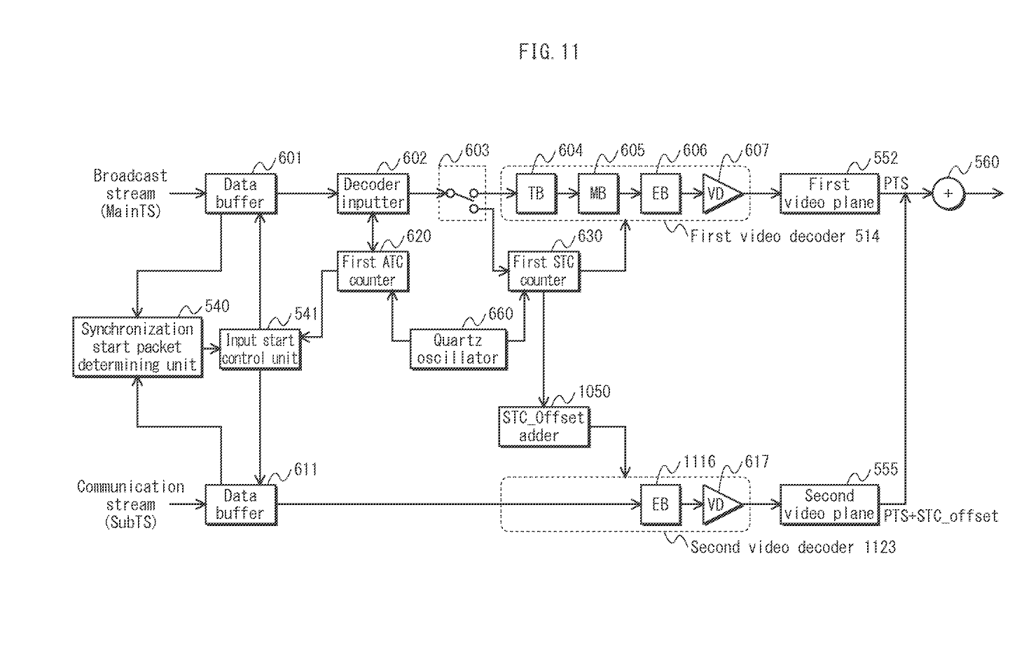

FIG. 11 is a diagram illustrating a structure of the second modified primary video decoding unit.

As illustrated in FIG. 11, the second modified primary video decoding unit is yielded by modifying the first modified primary video decoding unit in modification 1 (refer to FIG. 10) such that the decoder inputter 612, the PID filter 613, and the ATC_Offset adder 1040 are deleted and the second video decoder 523 is replaced with a second video decoder 1123.

The second video decoder 1123 is yielded by modifying the second video decoder 523 in modification 1 such that the TB 614 and the MB 615 are deleted and the EB 616 is replaced with an EB 1116.

The EB 1116 is a buffer for storing pictures in an encoded state, and has the function of removing a PES packet header from a PES packet transmitted from the data buffer 611.

In the second modified display device, the input start control unit 541 starts the output of the broadcast stream from the data buffer 601 to the decoder inputter 602 after waiting until a sufficient amount of data is accumulated in the EB 1116 (for example, until when data corresponding to one second is accumulated in the EB 1116, or until when the storage capacity of the EB 1116 becomes full). Meanwhile, the input start control unit 541 continuously outputs data of the communication stream from the data buffer 611 to the EB 1116 such that underflow of the EB 1116 does not occur.

<Observation>

The second modified display device having the above-described structure, similar as the first modified display device in modification 1, decodes the broadcast stream along the STC1 time axis and decodes the communication stream along the STC2 time axis, which is calculated by adding the STC_Offset to the STC1 time axis. Accordingly, received broadcast video and received communication video can be displayed in synchronization at the timing intended by the video content producer.

### <Modification 3>

<Overview>

In the following, as one example of implementation of the display device pertaining to the present invention, description is provided on a third modified display device that is yielded by modifying a part of the display device 110 in the above embodiment.

The display device 110 in the embodiment has a structure where the plane synthesizing processing unit 560 combines video frames output from the first video decoder 514 and video frames output from the second video decoder 523.

In contrast, the third modified display device is an example of a structure for remultiplexing video frames output from the first video decoder 514 and video frames output from the second video decoder 523.

In the following, description is provided on the structure of the third modified display device in modification 3 while focusing on the differences thereof with the display device 110 in the embodiment and with reference to the accompanying drawings.

<Structure>The third modified display device is yielded by modifying the display device 110 in the embodiment such that the primary video decoding unit is replaced with a third modified primary video decoding unit.

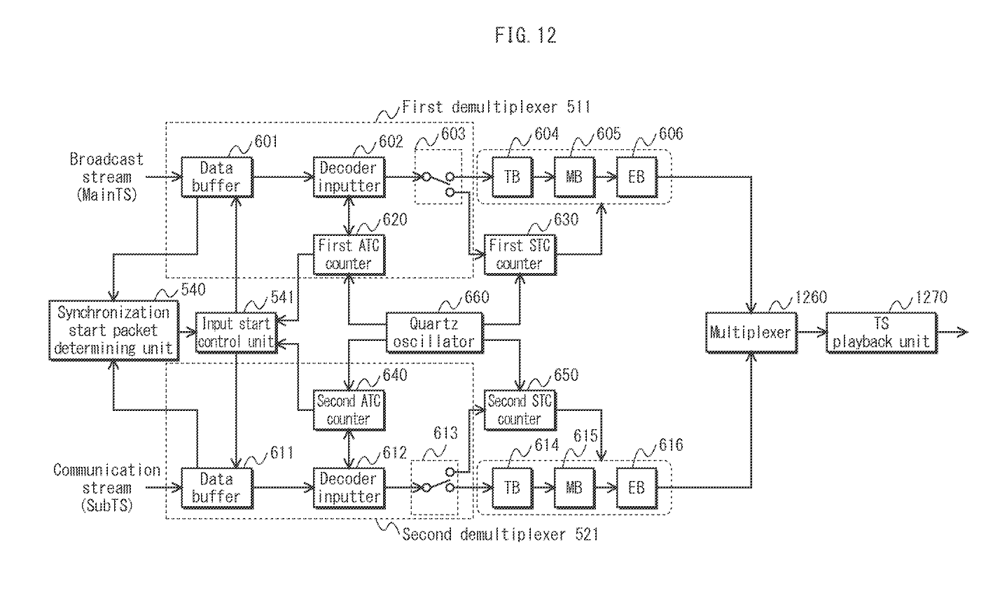

FIG. 12 is a diagram illustrating a structure of the third modified primary video decoding unit.

As illustrated in FIG. 11, the third modified primary video decoding unit is yielded by modifying the primary video decoding unit in the embodiment (refer to FIG. 6) such that the plane synthesizing processing unit 560, the video decoder 607, and the video decoder 617 are deleted and a multiplexer 1260 and a TS playback unit 1270 are added.

The multiplexer 1260 has the function of generating a TS packet sequence (hereinafter referred to as a “second broadcast stream”) from the encoded video frame sequence output from the EB 606, generating a TS packet sequence (hereinafter referred to as a “second communication stream”) from the encoded video frame sequence output from the EB 616, multiplexing the second broadcast stream and the second communication stream so generated, and outputting a synthesized stream.

Here, the multiplexer 1260 doubles the system rate of each of the second broadcast stream and the second communication stream when multiplexing the second broadcast stream and the second communication stream.

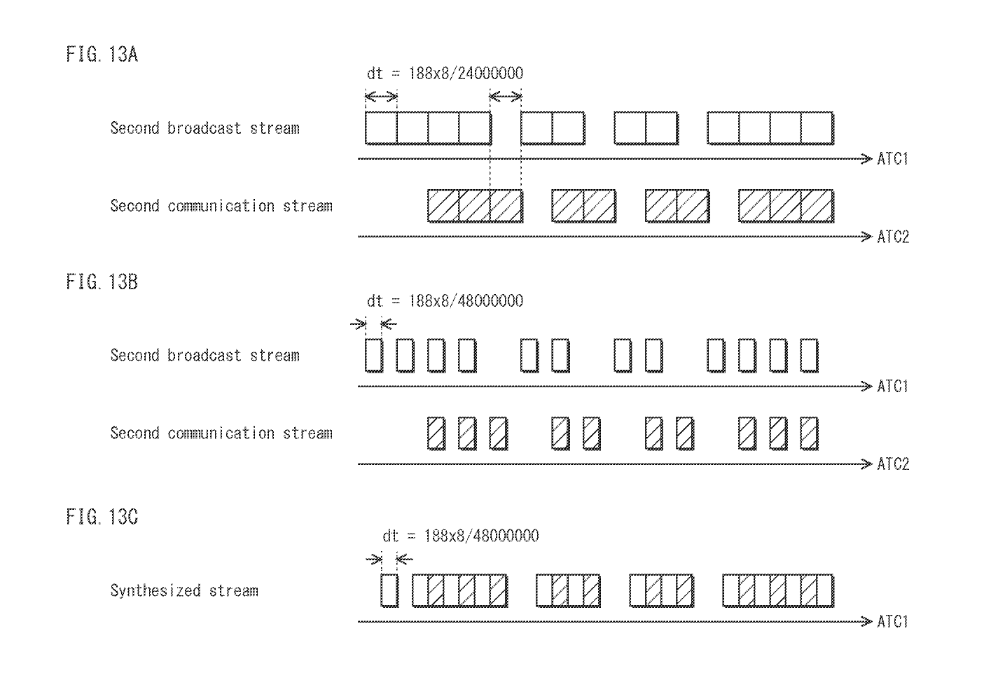

FIG. 13A is a timing chart of the TS packet sequence of the second broadcast stream and the TS packet sequence of the second communication stream before the doubling of system rates is performed. Here, description is provided based on an assumption that the second broadcast stream and the second communication stream have the same system rate of 24 Mbps before the doubling of system rates.

Each of the boxes illustrated in FIG. 13A indicates a TS packet constituting a TS packet sequence, and “dt”, which denotes a width of each box, indicates the time from the input of a TS packet to the corresponding PID filter to the output of the TS packet from the corresponding PID filter. Here, “dt” satisfies: dt=188×8/240000000.

FIG. 13B is a timing chart of the TS packet sequence of the second broadcast stream and the TS packet sequence of the second communication stream after the doubling of system rates is performed. FIG. 13B illustrates a case where the system rate of each of the second broadcast stream and the second communication stream has been doubled from 24 Mbps to 48 Mbps. Due to this, “dt” satisfies: dt=188×8/480000000.

FIG. 13C is a timing chart of a TS packet sequence of the synthesized stream.

As can be seen from the illustration in FIGS. 13B and 13C, by doubling the system rate of each of the second broadcast stream and the second communication stream before multiplexing the second broadcast stream and the second communication stream, the multiplexing of the second broadcast stream and the second communication stream can be facilitated.

Here, one example of a method for converting ATC2 to ATC1 is the method described in modification 1 of calculating the ATC_Offset.

Returning to FIG. 12 once again, description on the third modified primary video decoding unit continues.

The TS playback unit 1270 has the function of separating the second broadcast stream and the second communication stream from the synthesized stream transmitted from the multiplexer 1260, and outputting video frames included in the second broadcast stream and video frames included in the second communication stream in synchronization.

<Observation>

According to the third modified display device having the above-described structure, the synthesized stream generated by the multiplexer 1260 is a stream generated by performing multiplexing while taking into consideration the STC_offset. Accordingly, the synthesized stream generated by the multiplexer 1260 resembles a regular TS stream. As such, the synthesized stream generated by the multiplexer 1260 can be stored onto an optical disc or the like and can be played back on a different playback device.

### <Modification 4>

<Overview>

In the following, as one example of implementation of the display device pertaining to the present invention, description is provided on a fourth modified display device that is yielded by modifying a part of the display device 110 in the above embodiment.

The display device 110 in the embodiment has a structure for performing synchronized display of broadcast video and communication video by utilizing four time axes, namely, the ATC1 time axis, the ATC2 time axis, the STC1 time axis, and the STC2 time axis.

In contrast, the fourth modified display device in modification 4 is an example of a structure for performing synchronized display of broadcast video and communication video by using five time axes, i.e., the four time axes listed above and an AbsTime time axis.

In the following, description is provided on the structure of the fourth modified display device in modification 4 while focusing on the differences thereof with the display device 110 in the embodiment and with reference to the accompanying drawings.

<Structure>

The fourth modified display device is yielded by modifying the display device 110 in the embodiment such that the primary video decoding unit is replaced with a fourth modified primary video decoding unit.

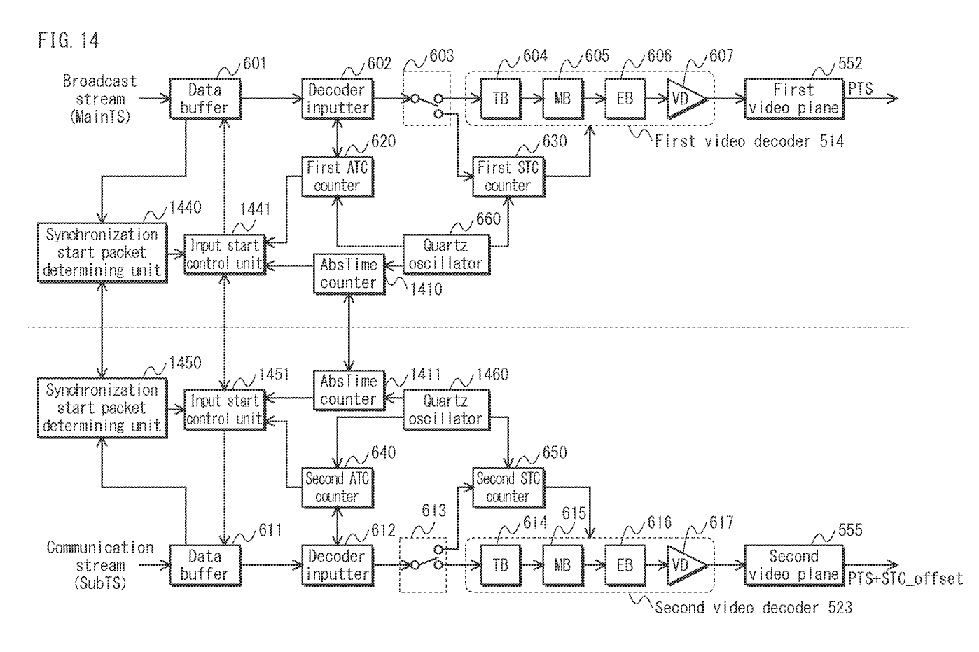

FIG. 14 is a diagram illustrating a structure of the fourth modified primary video decoding unit.

As illustrated in FIG. 14, the fourth modified primary video decoding unit is yielded by modifying the primary video decoding unit in the embodiment (refer to FIG. 6) such that the synchronization start packet determining unit 540 and the input start control unit 541 are deleted and a synchronization start packet determining unit 1440, a synchronization start packet determining unit 1450, an input start control unit 1441, an input start control unit 1451, a quartz oscillator 1460, an AbsTime counter 1410, and an AbsTime counter 1411 are added.

Further, the constituent elements illustrated above the broken line in FIG. 14 are stored in a first body (e.g., a television image receiver), while the constituent elements illustrated below the broken line are stored in a second body (e.g., a tablet terminal).

The quartz oscillator 1460, similar as the quartz oscillator 660, is an oscillator that utilizes the piezoelectric effect of quartz and oscillates at a frequency of 27 MHz.

The AbsTime counter 1410 and the AbsTime counter 1411 are counters that measure the time on the AbsTime time axis, and each have the function of incrementing a value (indicating time on the AbsTime time axis) at the frequency of 27 MHz. More specifically, the AbsTime counter 1410 and the AbsTime counter 1411 respectively utilize the oscillation of the quartz oscillator 660 and the quartz oscillator 1460.

Note that here, the AbsTime is time measured by a real time clock (RTC).

In addition, the AbsTime counter 1410 and the AbsTime counter 1411 have the function of communicating with one another by utilizing a network time protocol (NTP) or the like, and through the communication, the AbsTime kept by the AbsTime counter 1410 and the AbsTime kept by the AbsTime counter 1410 are synchronized to indicate the same time.

The synchronization start packet determining unit 1440 and the synchronization start packet determining unit 1450 have the function of communicating with one another, and a combination of the synchronization start packet determining unit 1440 and the synchronization start packet determining unit 1450 realizes functions similar to those of the synchronization start packet determining unit 540 in the embodiment.

The input start control unit 1441 and the input start control unit 1451 have the function of communicating with one another, and a combination of the input start control unit 1441 and the input start control unit 1451 realizes functions similar to those of the input start control unit 541 in the embodiment. Here, the input start control unit 1441 utilizes the five time axes listed above, i.e., the ATC1 time axis, the ATC2 time axis, the STC1 time axis, the STC2 time axis, and the AbsTime time axis to realize the function of determining the timing for inputting the broadcast stream stored in the data buffer 601 to the decoder inputter 602. Similarly, the input start control unit 1451 utilizes the five time axes listed above, i.e., the ATC1 time axis, the ATC2 time axis, the STC1 time axis, the STC2 time axis, and the AbsTime time axis to realize the function of determining the timing for inputting the communication stream stored in the data buffer 611 to the decoder inputter 612.

In the following, description is provided on how the input start control unit 1541 determines the above-described output timing, with reference to the accompanying drawings.

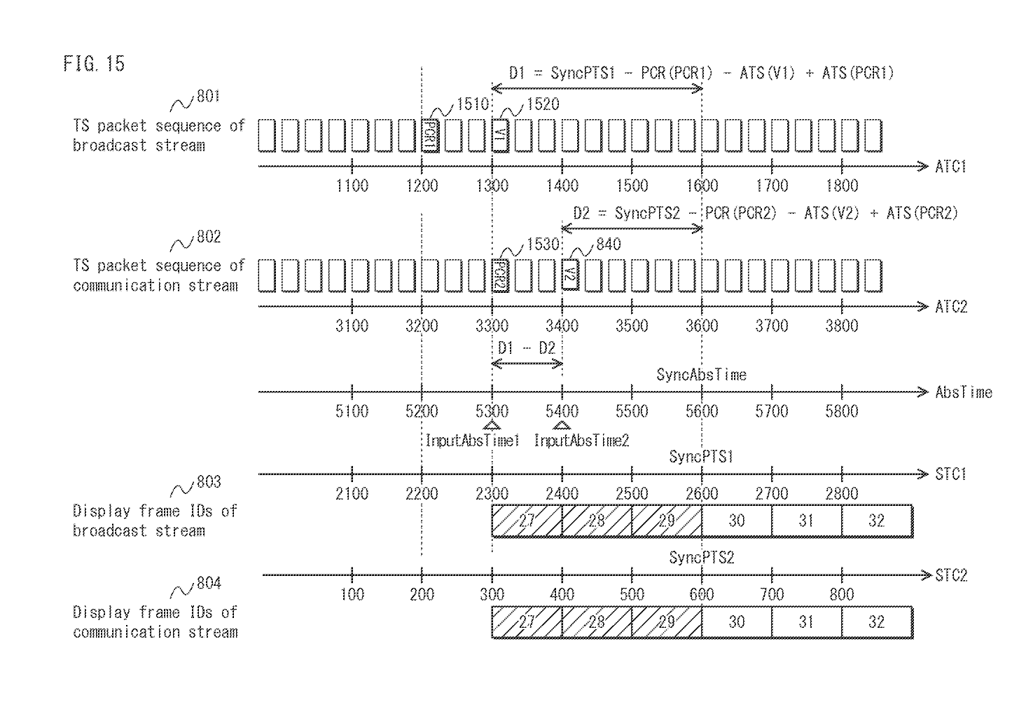

FIG. 15 is a timing chart similar to FIG. 9 but differing in that the AbsTime time axis is added. Note that FIG. 15 illustrates a case where “SyncAbsTime”, which is a value on the AbsTime time axis indicating when synchronized display is started, is set to “5600”.

In this case, the timing at which the output of the synchronization start TS packet (V1) of the broadcast stream to the decoder inputter 602 is to be started can be calculated, on the AbsTime time axis, as SyncAbsTime−D1, and therefore, is calculated as 5600−300=5300. Here, this timing, on the AbsTime time axis, at which the output of the synchronization start TS packet (V1) of the broadcast stream to the decoder inputter 602 is to be started is referred to as “InputAbsTime1”.

Additionally, in this case, the timing at which output of the synchronization start TS packet (V2) of the communication stream to the decoder inputter 612 is to be started can be calculated, on the AbsTime time axis, as SyncAbsTime−D2, and therefore, is calculated as 5600−200=5400. Here, this timing, on the AbsTime time axis, at which the output of the synchronization start TS packet (V2) of the communication stream to the decoder inputter 612 is to be started is referred to as “InputAbsTime2”. The input start control unit 1441 starts the input of the synchronization start TS packet (V1) of the broadcast stream to the decoder inputter 602 at InputAbsTime1. The input start control unit 1451 starts the input of the synchronization start TS packet (V2) of the communication stream to the decoder inputter 612 at InputAbsTime2. Accordingly, the synchronized display of each video frame of the broadcast stream and a corresponding video frame of the communication stream, at the timing indicated by the SyncAbsTime, is realized.

<Observation>

According to the fourth modified display device having the above-described structure, an image stored in the first video plane 552 is displayed on a display included in the first body, and an image stored in the second video plane 555 is displayed on a display included in the second body. As such, received broadcast video and received communication video can be respectively displayed by the first body and the second body in synchronization at the timing intended by the video content producer.

### <Modification 5>

<Overview>

In the following, as one example of implementation of the display device pertaining to the present invention, description is provided on a fifth modified display device that is yielded by modifying a part of the first modified display device in modification 1.

The first modified display device in modification 1 has a structure corresponding to when the communication stream transmitted by the communication service providing station 130 is a TTS stream in the MPEG-2 TS format.

In contrast, the fifth modified display device in modification 5 is an example of a structure corresponding to when the communication service providing station 130 transmits graphics data to be displayed in synchronization with broadcast video. Here, when the broadcast video is video of a soccer match, the graphics data may be, for example, information related to players in the soccer match, such as player names.

In the following, description is provided on the structure of the fifth modified display device in modification 5 while focusing on the differences thereof with the first modified display device in modification 1 and with reference to the accompanying drawings.

<Structure>

The fifth modified display device is yielded by modifying the first modified display device in modification 1 such that the first modified primary video decoding unit is replaced with a fifth modified primary video decoding unit.

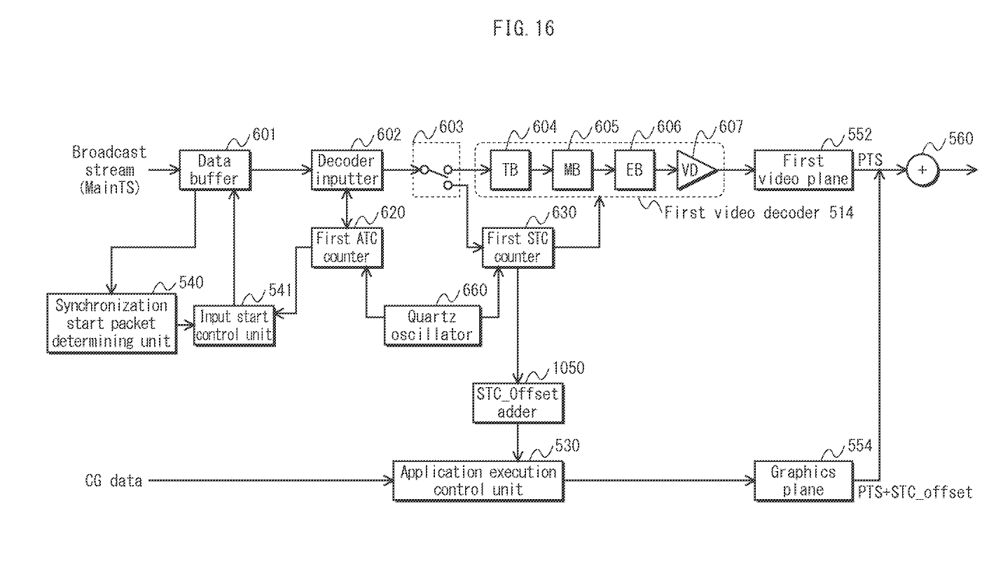

FIG. 16 is a diagram illustrating a structure of the fifth modified primary video decoding unit.

As illustrated in FIG. 16, the fifth modified primary video decoding unit is yielded by modifying the first modified primary video decoding unit in modification 1 (refer to FIG. 10) such that the data buffer 611, the decoder inputter 612, the PID filter 613, the TB 614, the MB 615, the EB 616, the video decoder 617, the second video plane 555, and the ATC_Offset adder 1040 are deleted and the application execution control unit 530 and the graphics plane 554 are added.

In modification 5, the application execution control unit 530, by executing an application, draws a CG image from the CG image data obtained by the communication interface 502 and outputs the CG image drawn to the graphics plane 554.

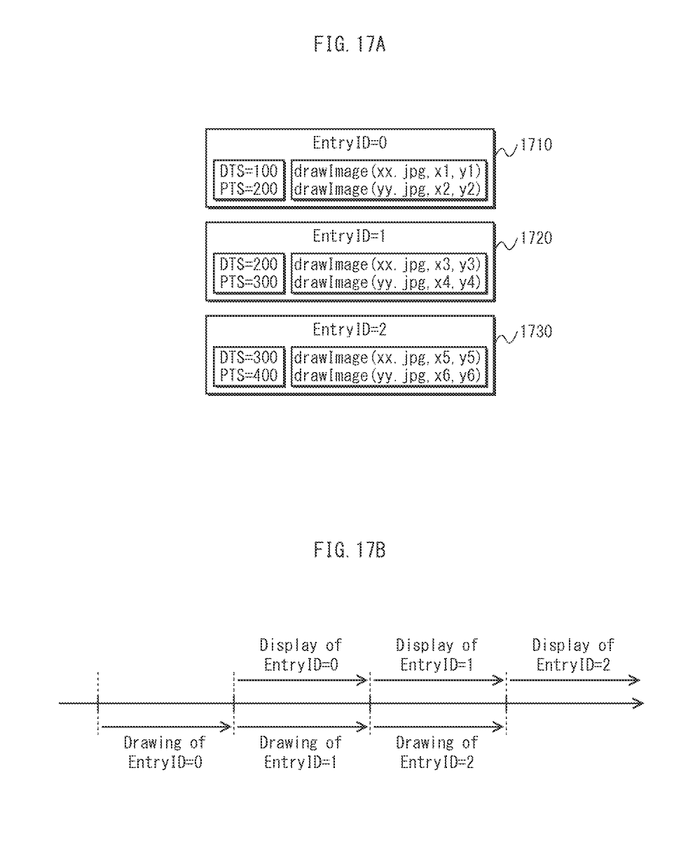

FIG. 17A is a diagram illustrating one example of a data structure of the CG image data.

As illustrated in FIG. 17A, the CG image data is drawing instruction data provided with a DTS and a PTS. Here, the drawing instruction data is assumed to be a script code, and for example, when the application is in the HTML format, the drawing instruction data is a graphics drawing code in JavaScript™.

The application execution control unit 530, by executing the application, starts drawing at the timing, on the STC2 time axis, indicated by the DTS output from the STC_Offset adder 1050, and outputs the CG image drawn to the graphics plane 554.

Here, description is provided based on an example where the application acquires the present time by utilizing a function such as GetCurrentTime(stc), starts the drawing at the timing indicated by the DTS, and outputs the CG image drawn at a designated time (outputPTS).

In addition, assumption is made in modification 5 that the graphics plane 554 has a double buffer structure.

FIG. 17B is a timing chart illustrating the timings at which CG images are drawn and the timings at which the CG images so drawn are displayed.

As illustrated in FIG. 17B, the application execution control unit 530 starts the drawing by using one of the two buffers of the graphics plane 554 at the timing indicated by the DTS, and the graphics plane 554 displays the drawn CG image at the timing indicated by the PTS.

As such, by configuring the graphics plane 554 to have a double buffer structure as described above, smooth display of CG images is realized.

Note that the application execution control unit 530 may also realize the functions of the synchronization start packet determining unit 540 and the input start control unit 541 by executing an application. In such a case, the application execution control unit 530 may acquire a GOP information table by utilizing a function such as GetGOPTable(gop_table), may determine a synchronization start TS packet according to PTSs or the like included in the GOP information table so acquired, and may issue an instruction for starting execution by utilizing a function such as SetStartPTS(pts) and SetStartFrameID(frameID).

<Observation>

The fifth modified display device having the above-described structure is similar to the first modified display device in modification 1, and decodes the broadcast stream along the STC1 time axis and performs the drawing and the output of the CG image along the STC2 time axis, which is calculated by adding the STC_Offset to the STC1 time axis. Accordingly, received broadcast video and a CG image corresponding to received CG image data can be displayed in synchronization at the timing intended by the video content producer.

### <Modification 6>

<Overview>

In the following, as one example of implementation of the display device pertaining to the present invention, description is provided on a sixth modified display device that is yielded by modifying a part of the fifth modified display device in modification 5.

The sixth modified display device is an example of a structure where a graphics engine, which is a hardware accelerator that draws a CG image, is added to the fifth modified display device in modification 5.

In the following, description is provided on the structure of the sixth modified display device in modification 6 while focusing on the differences thereof with the fifth modified display device in modification 5 and with reference to the accompanying drawings.

<Structure>

The sixth modified display device is yielded by modifying the fifth modified display device in modification 5 such that the fifth modified primary video decoding unit is replaced with a sixth modified primary video decoding unit.

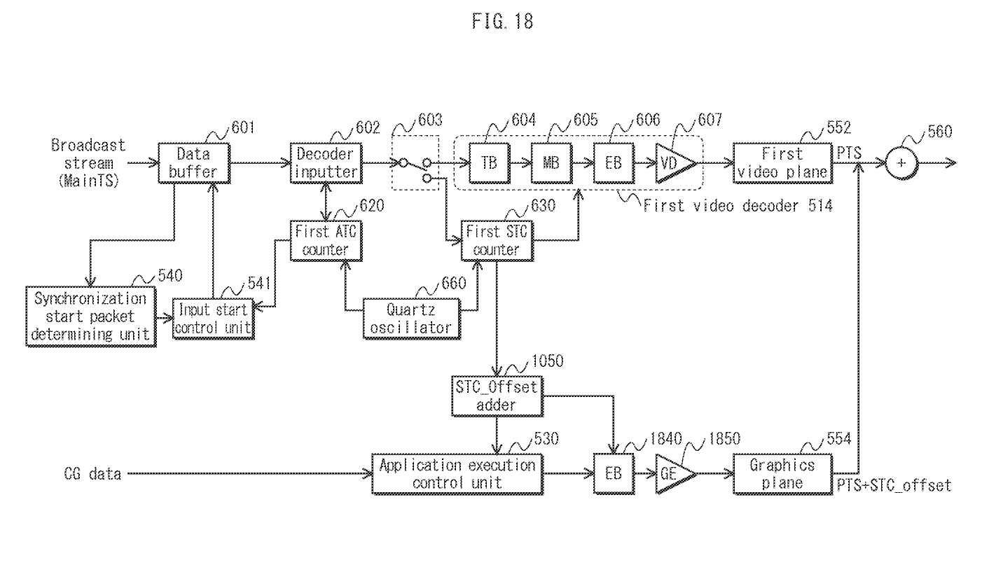

FIG. 18 is a diagram illustrating a structure of the sixth modified primary video decoding unit.

As illustrated in FIG. 18, the sixth modified primary video decoding unit is yielded by modifying the fifth modified primary video decoding unit in modification 5 (refer to FIG. 16) such that an EB 1840 and a graphics engine 1850 are added.

The EB 1840 is a buffer for storing CG image data.

In modification 6, the application execution control unit 530, by executing an application, causes the EB 1840 to accumulate the CG image data acquired by the communication interface 502.

The graphics engine 1850 has the function of performing drawing based on the CG image data stored in the EB 1840 at the timing indicated by the DTS, and outputting the result of the drawing to the graphics plane 554.

### <Modification 7>

<Overview>

In the following, as one example of implementation of the display device pertaining to the present invention, description is provided on a seventh modified display device that is yielded by modifying a part of the display device 110 in the embodiment.

The display device 110 in the embodiment has a structure corresponding to a case where the frame ID of the synchronization start packet of the broadcast stream (corresponding to the top video frame of one of the GOPs in the broadcast stream) matches the frame ID of the synchronization start packet of the communication stream (corresponding to the top video frame of one of the GOPs in the communication stream).

In contrast, the seventh modified display device in modification 7 is an example of a structure corresponding to a case where the frame ID of the synchronization start packet of the broadcast stream (corresponding to the top video frame of one of the GOPs in the broadcast stream) and the frame ID of the synchronization start packet of the communication stream (corresponding to the top video frame of one of the GOPs in the communication stream) do not match.

In this example, each video frame included in the broadcast stream transmitted by the broadcasting station 120 and the communication stream transmitted by the communication service providing station 130 has appended thereto a frame ID identifying the video frame.

Specifically, in each of the broadcast stream and the communication stream, frame IDs are appended to the video frames therein incrementing in display order from the top video frame in the stream. In addition, the appending of the frame IDs to the video frames included in the broadcast stream and the appending of the frame IDs to the video frames included in the communication stream are performed such that the same frame ID is appended to both a video frame in the broadcast stream and a video frame in the communication stream that are to be displayed in synchronization.

In the following, description is provided on the structure of the seventh modified display device in modification 7 while focusing on the differences thereof with the display device 110 in the embodiment and with reference to the accompanying drawings.

<Structure>

The seventh modified display device is yielded by modifying the display device 110 in the embodiment such that the primary video decoding unit is replaced with a seventh modified primary video decoding unit.

Note that illustration is not provided of the seventh modified primary video decoding unit, and description on the seventh modified primary video decoding unit is provided while referring to FIG. 6, which illustrates the primary video decoding unit in the embodiment.

In modification 7, the synchronization start packet determining unit 540 obtains, from the broadcast stream stored in the data buffer 601, the memory addresses of the top TS packets of the GOPs, the PTS values of the top TS packets, the frame IDs of the top TS packets, and the STC_Offset stored in the SI, and obtains, from the communication stream stored in the data buffer 611, the memory addresses of the top TS packets of the GOPs, the PTS values of the top TS packets, and the frame IDs of the top TS packets. Further, by using the information obtained, the synchronization start packet determining unit 540 generates a modified first GOP information table and a modified second GOP information table.

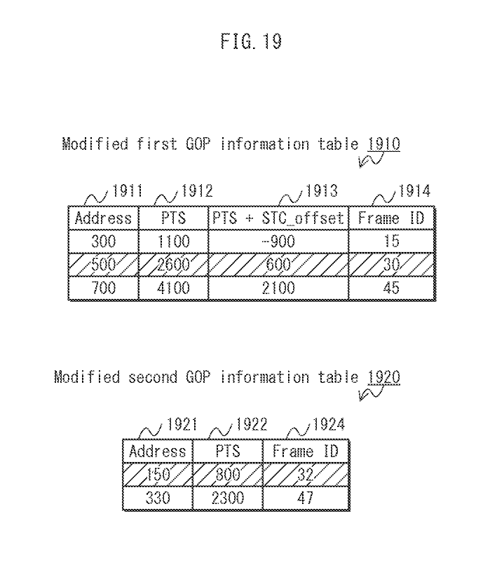

FIG. 19 illustrates a modified first GOP information table 1910 and a modified second GOP information table 1920. The modified first GOP information table 1910 and the modified second GOP information table 1920 are examples of the modified first GOP information table and the modified second GOP information table generated by the synchronization start packet determining unit 540, respectively.

As illustrated in FIG. 19, the modified first GOP information table 1910 is a table having an address field 1911, a PTS field 1912, a PTS+STC_offset field 1913, and a frame ID field 1914. A value in the address field 1911, the corresponding value in the PTS field 1912, the corresponding value in the PTS+STC_offset field 1913, and the corresponding value in the frame ID field 1914 are assocated with one another.

The address field 1911, the PTS field 1912, and the PTS+STC_offset field 1913 are similar to the address field 711, the field PTS 712, and the PTS+STC_offset field 713 in the embodiment, respectively (refer to FIG. 7B).

The values in the frame ID field 1914 each indicate a frame ID of the top TS packet stored at the address indicated by the corresponding value in the address field 1911.

As illustrated in FIG. 19, the modified second GOP information table 1920 is a table having an address field 1921, a PTS field 1922, and a frame ID field 1924. A value in the address field 1921, the corresponding value in the PTS field 1922, and the corresponding value in the frame ID field 1924 are assocated with one another.

The address field 1921, the PTS field 1922, and the frame ID field 1924 are similar to the address field 1911, the field PTS 1912, and the frame ID field 1914, respectively (refer to FIG. 19).

In the example illustrated in FIG. 19, an entry corresponding to an address “500” has a frame ID “30” in the modified GOP information table 1910, whereas an entry corresponding to an address “150” has a frame ID “32” in the modified GOP information table 1920.

In such a case, the synchronization start packet determining unit 540 first determines an entry in the modified GOP information table 1910 as the synchronization start TS packet in the broadcast stream. For instance, in the example illustrated in FIG. 19, the synchronization start packet determining unit 540 determines the entry having the frame ID “30” as the synchronization start TS packet in the broadcast stream. Then, the synchronization start packet determining unit 540 searches in the modified second GOP information table 1920 for an entry having a frame ID that is closest in value from the frame ID of the entry in the modified first GOP information table 1910 determined as the synchronization start

TS packet in the broadcast stream, from among entries having frame IDs later, in the time domain, than the entry in the modified first GOP information table 1910 determined as the synchronization start TS packet in the broadcast stream. For instance, in the example illustrated in FIG. 19, the synchronization start packet determining unit 540 specifies the entry having the frame ID “32” as a result of the search.

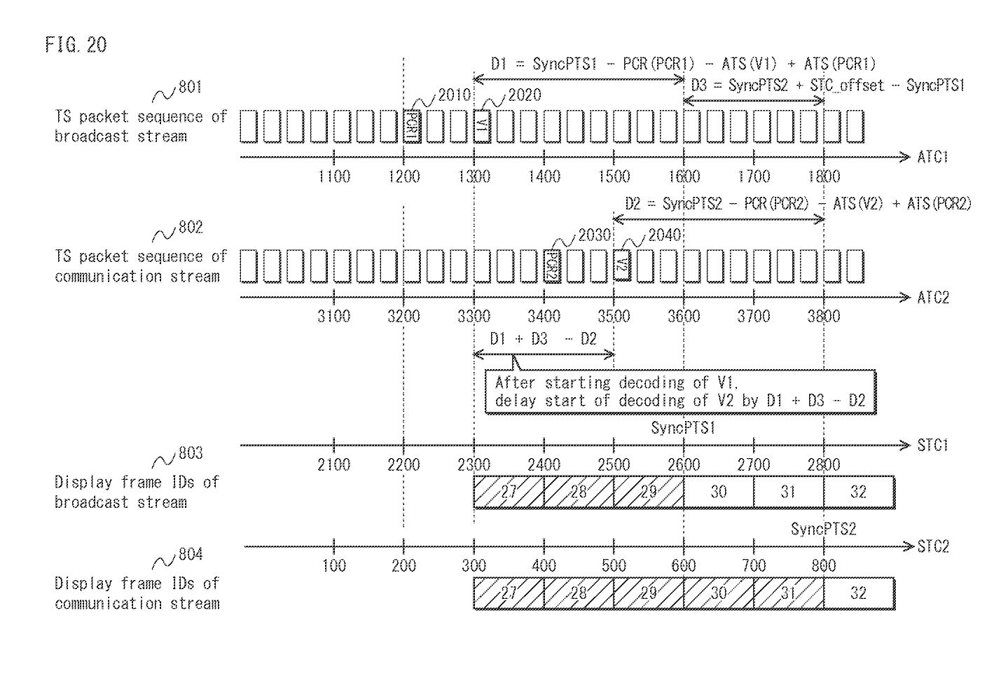

FIG. 20 is a timing chart illustrating, in the seventh modified display device, the timing at which the decoder inputter 602 outputs a TS packet sequence of the broadcast stream to the PID filter 603, the timing at which the decoder inputter 612 outputs a TS packet sequence of the communication stream to the PID filter 613, and the timings at which the video frames obtained by decoding the packet sequences are output to the corresponding video planes.

The input start control unit 541 determines the timings at which input to the decoders are to be performed as illustrated in FIG. 20. First, according to the same method as described with reference to FIG. 8, the input start control unit 541 calculates D1 and D2. Subsequently, the input start control unit 541 calculates a value “D3”, which indicates a difference between a synchronization start PTS of the broadcast stream (“SyncPTS1”) and a synchronization start PTS of the communication stream (“SyncPTS2”), when SyncPTS1 and SyncPTS2 are projected on the same time axis. Specifically, D3 can be calculated by performing calculation of D3=SyncPTS2+STC_Offset−SyncPTS1. The input start control unit 541 inputs V1 to the corresponding decoder while delaying the start of the input of V2 to the corresponding decoder by D1+D3−D2 with respect to the start of input of V1 to the corresponding decoder. In this way, synchronized playback of the broadcast stream and the communication stream is realized even in a case where the time at the top of the GOP in the broadcast stream at which synchronization is to be started and the time at the top of the GOP in the communication stream at which synchronization is to be started do not match.

Note that in a case as illustrated in FIG. 19, where the broadcast stream and the communication stream do not have matching GOP structures, modification may be made such that the display of a top GOP of the broadcast stream is not performed until a display time of the corresponding top GOP of the communication stream arrives. This is since the communication stream is “later” than the broadcast stream in the time domain. Alternatively, the display may be performed such that first, display is performed of the broadcast stream, and then display is performed of the communication stream, as illustrated in FIG. 20. Alternatively, modification may be made such that a user is able to make a selection of how the broadcast stream and the communication stream, existing “later” in the time domain, are to be displayed.

Further, note that the same PTS values may be used as frame ID values in both the broadcast stream and the communication stream. Alternatively, the same TimeCode values may be used as frame ID values in both the broadcast stream and the communication stream. By making such a modification, for example, the calculation of D3 in FIG. 20 can be facilitated since such values can be used as-is without the need of any additional calculation.

### <Modification 8>

<Overview>In the following, as one example of implementation of the display device pertaining to the present invention, description is provided on an eighth modified display device that is yielded by modifying a part of the display device 110 in the embodiment.

The display device 110 in the embodiment has a structure corresponding to a case where the broadcast stream transmitted by the broadcasting station 120 is a TTS stream in the MPEG-2 TS format.

In contrast, the eighth modified display device in modification 8 is an example of a structure corresponding to a case where the broadcast stream transmitted by the broadcasting station 120 is a TS stream in the MPEG-2 TS format.

In the following, description is provided on the structure of the eighth modified display device in modification 8 while focusing on the differences thereof with the display device 110 in the embodiment and with reference to the accompanying drawings.

<Structure>

The eighth modified display device is yielded by modifying the display device 110 in the embodiment such that a converter 2100 is added between the tuner 501 and the first demultiplexer 511 (refer to FIG. 5).

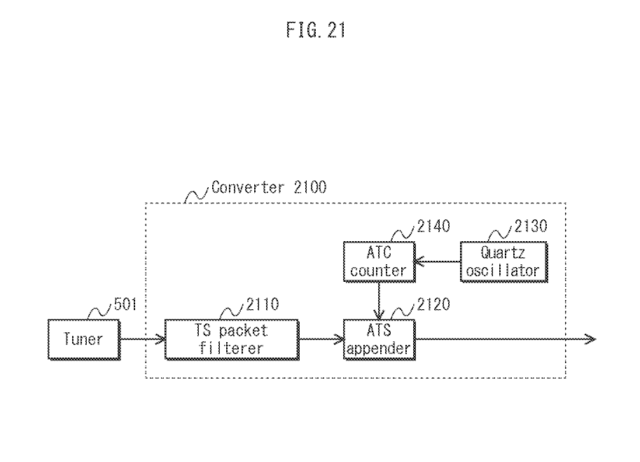

FIG. 21 is a diagram illustrating a structure of the converter 2100.

As illustrated in FIG. 21, the converter 2100 is composed of a quartz oscillator 2130, an ATC counter 2140, a TS packet filterer 2110, and an ATS appender 2120.

The quartz oscillator 2130 and the ATC counter 2140 are similar to the quartz oscillator 660 and the first ATC counter 620 in the embodiment (refer to FIG. 6), respectively.

The TS packet filterer 2110 performs filtering by using program information in an EIT packet and stream composition information in a program in a PMT packet to acquire TS packets constituting a program selected by a user, and outputs the TS packets acquired as a result of the filtering to the ATS appender 2120.

The ATS appender 2120 appends an ATS value to the top of each TS packet input thereto via the TS packet filterer 2110, which has a size of 188 bytes, by referring to the ATC value of the ATC counter 2140, and thereby generates TS packets each having a size of 192 bytes. Since the ATS field has a size of four bytes, the ATC value is a value from 0x0 to 0xFFFFFFFF0. As such, when the ATC value increases and becomes equal to or greater than 0xFFFFFFFF, the ATC value returns to zero (i.e., a “wrap-around”). Note that in the case of the Blu-ray format, the top two bits of the first four bytes of a TS packet is utilized for storing copy control information. Due to this, in the case of the Blu-ray format, the ATS value is a 30-bit value, and wrap-around takes place at 30 bits.

The converter 2100, due to having the structure illustrated in FIG. 21, has the function of appending an ATS to the top of each TS packet of the broadcast stream.

Further, due to the converter 2100 being arranged between the tuner 501 and the first demultiplexer 511, a TTS stream is input to the first demultiplexer 511 as the broadcast stream.

### <Other Modifications>

To realize synchronized playback of a broadcast stream and a communication stream, it is necessary to perform delayed playback. This is since, synchronized playback needs to be performed after buffering of both data of the broadcast stream and data of the communication stream, and also, network delay over the communication networks need to be taken into consideration.

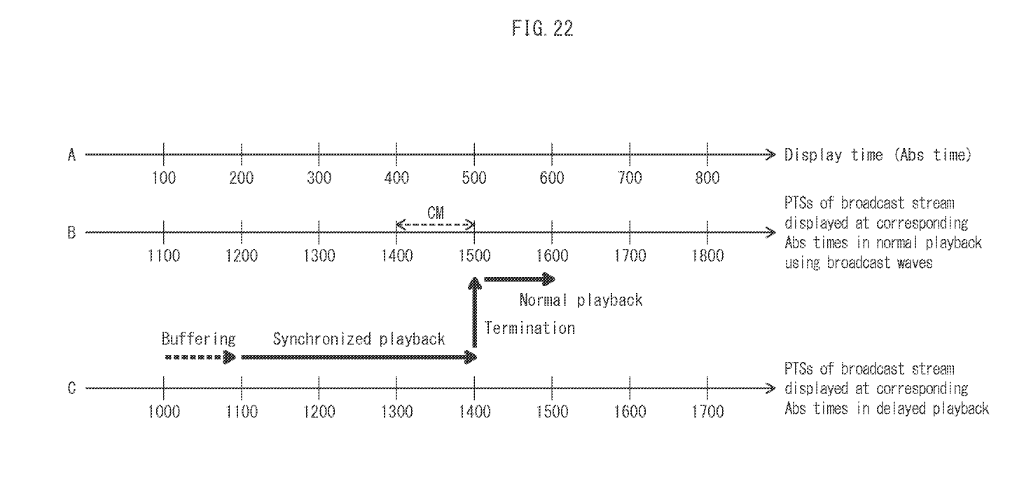

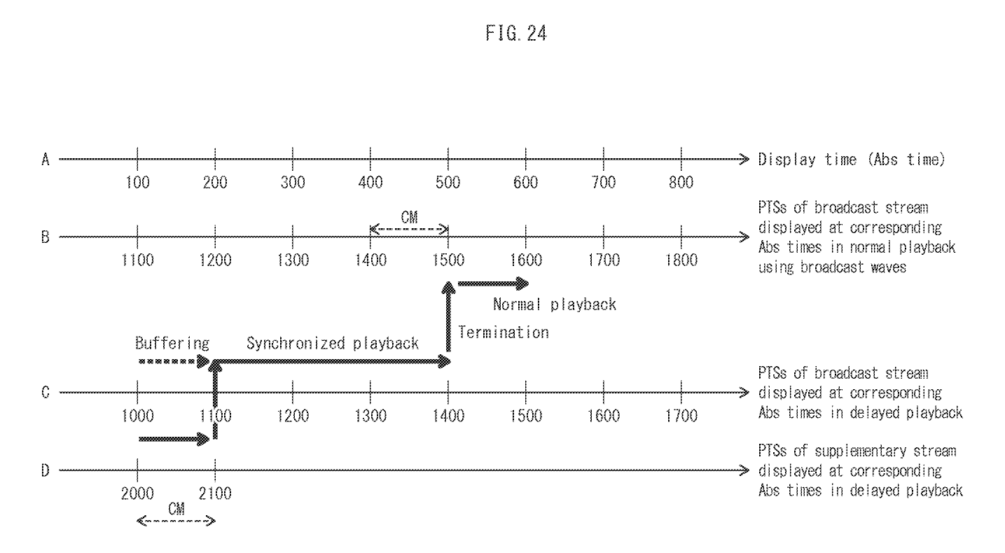

FIG. 22 illustrates a problem when conventional delayed playback is performed. Time line A indicates display time (AbsTime), and more specifically, indicates time information shared by terminals synchronized by means of NTP or the like, such as RTC. Time line B indicates PTSs of a video of a broadcast stream displayed at the corresponding display times (AbsTime) in normal playback using broadcast waves. Time line C indicates PTSs of a video of a broadcast stream displayed at the corresponding display times (AbsTime) when delayed playback is performed for realizing synchronized playback. In FIG. 24, note that the arrows illustrated between time lines B and C indicate the playback route in synchronized playback. First, buffering is performed between AbsTime “100” and AbsTime “200”, whereby data of the broadcast stream and data of the communication stream are stored to the data buffers. Subsequently, synchronized playback of the broadcast stream and the communication stream is performed between AbsTime “200” and AbsTime “500”. Further, synchronized playback is terminated at AbsTime “500”, and normal playback is performed from AbsTime “500”. In such a case as illustrated in FIG. 24, a problem arises in that display is not performed of data of the broadcast stream between PTS “1400” and PTS “1500”. For example, when the scene between PTS “1400” and PTS “1500” corresponds to a TV commercial, a user performing synchronized playback does not view the TV commercial. This is problematic since, if TV commercials were not viewed by users, broadcasting stations would not be able to continue their businesses.

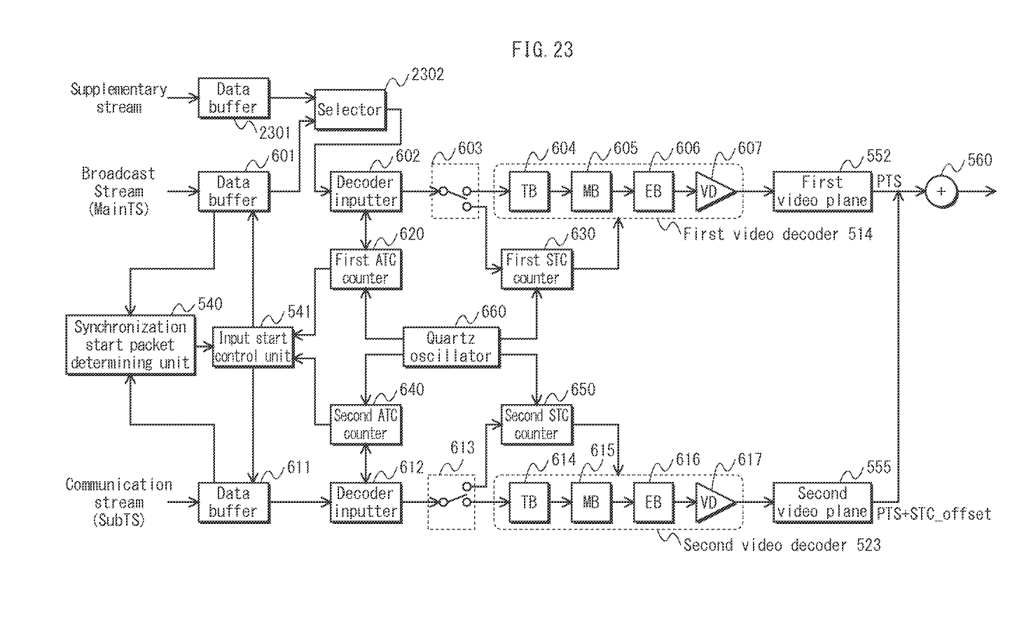

FIG. 23 illustrates a stream decoder for addressing the above-described problem. In FIG. 23, a selector 2302 is arranged in front of the decoder inputter 602. Due to this, not only can a broadcast stream be input but also data of a supplementary stream can be input. Here, the supplementary stream is a stream that supplements data corresponding to data of the broadcast stream that is not played back when performing synchronized playback. Further, it is preferable that the supplementary stream be downloaded in advance and stored to a data buffer 2301 (which is a HDD, for example). In FIG. 24, playback of the supplementary stream is performed while buffering of the broadcast stream and the communication stream is performed. Subsequently, switching is performed of the selector 2302 added in FIG. 23 when the buffering is completed, and synchronized playback of the broadcast stream and the communication stream is executed from the point when the buffering is completed. As such, by providing the supplementary stream with content corresponding to PTS “1400” to PTS “1500” of the broadcast stream, it can be ensured that the entire video of the broadcast stream is displayed to the user without any contents thereof not being displayed.

Note that in order to ensure that the contents as intended by the broadcasting station is displayed during the buffering, it is preferable that control of the start time of synchronized playback be enabled. That is, it is preferable that the setting of the display time (AbsTime) at which synchronized display is to be started be enabled via an API of an application, etc. Further, such information may be stored in the broadcast stream or the communication stream, or communication data acquirable from an application, etc. In addition, the control of the display time at which synchronized display is to be started can be performed according to the method indicated in FIG. 14.

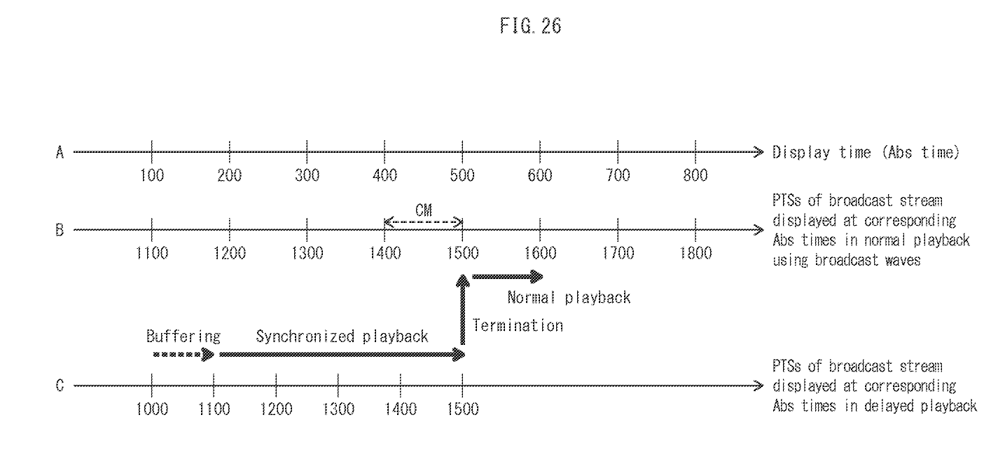

Further, as illustrated in FIG. 26, a modification may be made such that the PTS of the broadcast stream at the display time (AbsTime) when the synchronized playback is terminated matches the PTS of the broadcast stream in normal playback. This can be realized by increasing the playback speed in synchronized playback during a part of or the entire period during which synchronized playback is performed. In the example illustrated in FIG. 26, on the time line C of delayed playback, playback at increased speed is performed from PTS “1100” until PTS “1500” and is terminated at PTS “1500”, which corresponds to the same display timing on the time line B of normal playback.

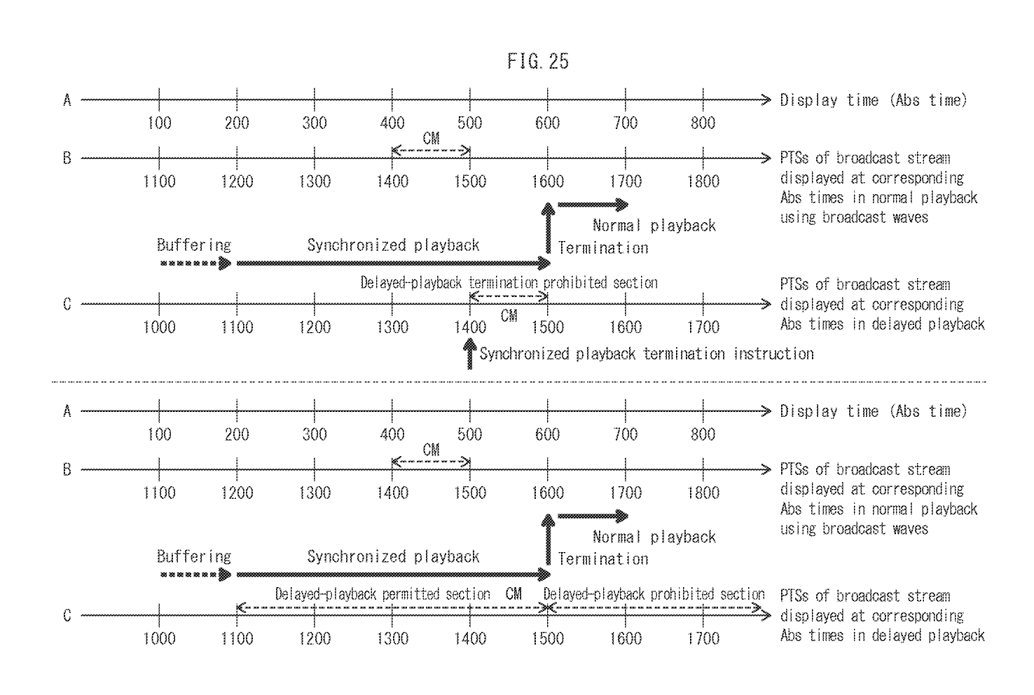

Further, as illustrated in FIG. 25, information identifying a delayed-playback termination prohibited section of the broadcast stream may be stored in the broadcast stream or the communication stream, or communication data acquirable from an application, etc. For example, in the example illustrated in the upper tier of FIG. 25, the section in the broadcast stream corresponding to PTS “1400” to PTS “1500” is set as the delayed-playback termination prohibited section. As such, even when an instruction for synchronized playback termination instruction is issued by the user at AbsTime “500”, synchronized playback is not terminated, and thus, delayed playback continues until the delayed-playback termination prohibited section ends. At the display time when the delayed-playback termination prohibited section ends, normal playback is performed. By making such a modification, it can be ensured that video as intended by the broadcasting station is displayed during the synchronized playback. Here, it should be noted that the determination of whether the synchronized playback termination instruction has been issued by the user within the delayed-playback termination prohibited section needs to be performed while also taking into consideration the buffering period. For instance, in the example illustrated in FIG. 25, since buffering is performed from PTS “1000” to PTS “1100” and hence, the duration of the buffering period is “100”, a determination is made that the section of the broadcast stream corresponding to the display time from AbsTime “400” to AbsTime “500”, or that is, the section between PTS “1300” and PTS “1400” of the broadcast stream, is within the delayed-playback termination prohibited section.

Further, as illustrated in FIG. 25, information identifying delayed-playback permitted sections and delayed-playback prohibited sections of the broadcast stream may be stored in the broadcast stream or the communication stream, or communication data acquirable from an application, etc. For instance, in the example illustrated in the lower tier of FIG. 25, the section of the broadcast stream from PTS “1100” to PTS “1500” is set as the delayed-playback permitted section, and the section of the broadcast stream from PTS “1500” and on is set as the delayed-playback prohibited section. In such a case, delayed playback is performed from display time AbsTime “200” to AbsTime “600”, and normal playback is performed following display time AbsTime “600”. By notifying playback devices of such information, the broadcasting station can control the on and off delayed playback as desired, and thus, smooth transition between programs can be realized.

Further, modification may be made that synchronized playback is terminated when an STC discontinuous point occurs in the midst of the broadcast stream or when a different video is inserted in the midst of the broadcast stream. To enable this, a synchronization termination signal is stored in the broadcast stream, the communication stream, or communication data or the like, and a stream decoding unit, when receiving the synchronization termination signal, terminates synchronized playback and returns to normal playback. Further, an application is notified of the termination of synchronized playback via an API or an Event provided to the application in advance. The application restarts the synchronized playback as necessary.

Note that for example, when information acquired via the interne (for example, Twitter comments) is displayed while delayed playback of a soccer match is being performed, a problem arises in that the video and the interne information do not synchronize with one another. This is due to the interne information not being delayed as the video, delayed playback of which is being performed. In order to solve this problem, a stream decoding unit that performs synchronized playback provides, to an application control unit that displays graphics, an API for obtaining a delay time. In such a case, the stream decoding unit can calculate the delay time by storing a decode start time (AbsTime) and a buffering start time (AbsTime) and by calculating the difference between the decode start time and the buffering start time. Alternatively, the stream decoding unit can calculate the approximate delay time by comparing the present time (AbsTime) and time data in a TOT packet of a stream currently being decoded. By using such a delay time, interne information (for example, Twitter comments) during the period of: present time−delay time, can be extracted and displayed. By making such a modification, synchronized display of video and interne information may be realized.

In addition, when performing zapping, where a transition is made from a first program synchronized playback of which is being performed to a second program, if buffering of the first program is reset, rebuffering of the first program is required when returning to synchronized playback of the first program. This leads to a troublesome situation for the user. In view of this, when zapping is performed, a menu may be displayed making an inquiry to the user of whether or not buffering of the first program is to be continued. When the user chooses to continue the buffering of the first program, the buffering of the communication stream to the corresponding data buffer is continued. Alternatively, modification may be made such that the specification of whether or not to continue buffering in the above-described situation can be set via a preference menu.

Further, data necessary for performing synchronized playback of a given program should be downloaded in advance, when possible. As such, a modification may be made such that, in a playback device, when a designation is made in advance to view or record a specific broadcast program, data necessary for synchronized playback of the program is downloaded to a HDD or the like. In such a case, the recording of a program synchronized playback of which is to be performed is performed without delay.

In addition, in order to correctly convey an emergency broadcast message to a user when synchronized playback is being performed, modification may be made such that when signals of an emergency broadcast message are included in the broadcast stream, delayed playback is immediately suspended and normal playback is resumed. This is realized by monitoring, at all times, whether signals of an emergency broadcast message is included in the broadcast stream stored in the data buffer.

FIG. 27 is a list of APIs of a synchronized playback control module that the application execution unit for realizing synchronized playback in the present modification provides. Here, description is provided based on the assumption that the application is in the HTML format. In the left-to-right direction in FIG. 27, the first column provides the names of methods, the second column provides an overview of each API, the third column provides parameters of each API, and the fourth column provides comments of each API. AddVideo is an API for adding an entry of a stream including a video stream and is specified by a video tag, etc., in HTML5. Further, by using parameters of the AddVideo API, designation can be made for a given stream of a video object (VideoObject), of whether or not the stream is a master stream (bMaster), of a start PTS of the stream (StartPTS), and of a PTS difference between the stream and a master stream (ptsOffset). Other parameters include a flag designating whether or not to perform loop playback by returning to the top of the stream when the stream terminates, a parameter for designating the order in which planes are to be synthesized, a parameter for designating transparency, and a parameter for designating the STC_Offset. AddAudio is an API for adding an entry of a stream including an audio stream, and is specified by an audio tag, etc., in HTML5. Further, by using parameters of the AddAudio API, designation is made, for a given stream, of an audio object

(AudioObject), of a start PTS on the stream (StartPTS), and of a PTS difference between the stream and a master stream (ptsOffset). Other parameters include a flag indicating whether or not to perform loop playback by returning to the top of the stream when the stream terminates and a mixing coefficient between the stream and master audio. AddCanvas is an API for adding a canvas object, which is a graphics drawing module in HTML 5. By using a parameter of the AddCanvas API, a canvas object can be designated. RemoveVideo, RemoveAudio, RemoveCanvas are APIs for deleting a video object, an audio object, and a canvas object having been added, respectively. Play is an API for instructing the start of synchronized playback. By using the parameters of the Play API, designation can be made of a playback delay time (StartUpDelay) and a playback mode (Mode). For example, the playback mode includes, in addition to PoutP and PinP, a mode for performing 3D playback by using the broadcast stream as left-view video and the communication stream as right-view video. Stop is an API for stopping synchronized playback, and Pause is an API for pausing synchronized playback. GetStartUpDelay is an API for obtaining the delay time.

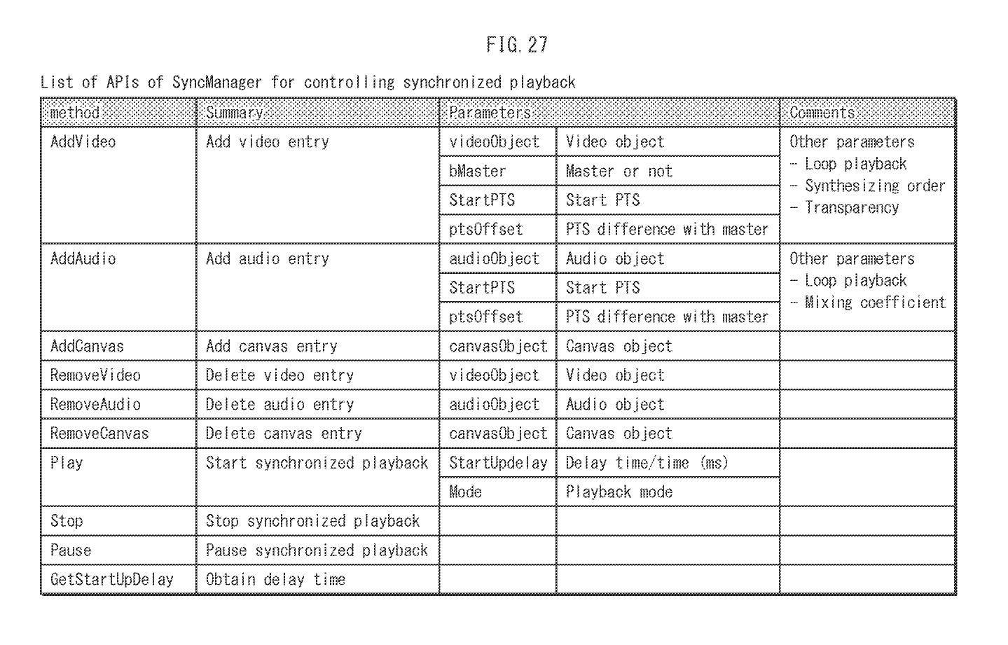

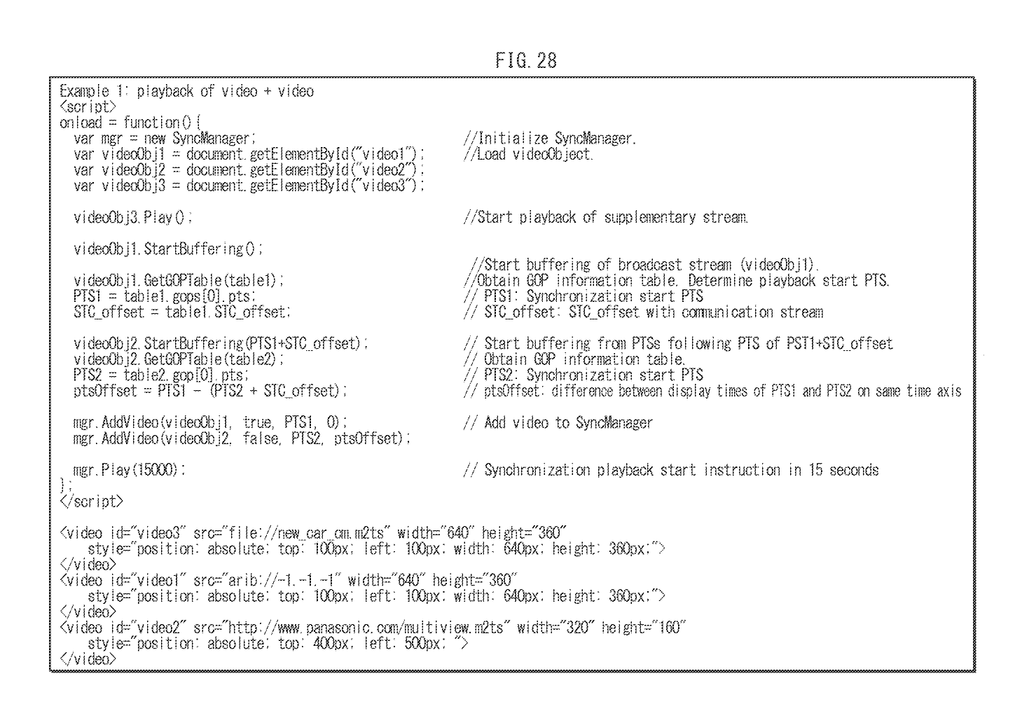

FIG. 28 is an example of a script in HTML5 for content extension, particularly when performing synchronized playback of a broadcast stream (video stream+audio stream) and a communication stream (video stream). In this case, three videos are defined by using video tags. The first is the supplementary stream, the second is the broadcast stream, and the third is the communication stream. Refer to the comments provided in FIG. 28 for explanation of Javascript operations.

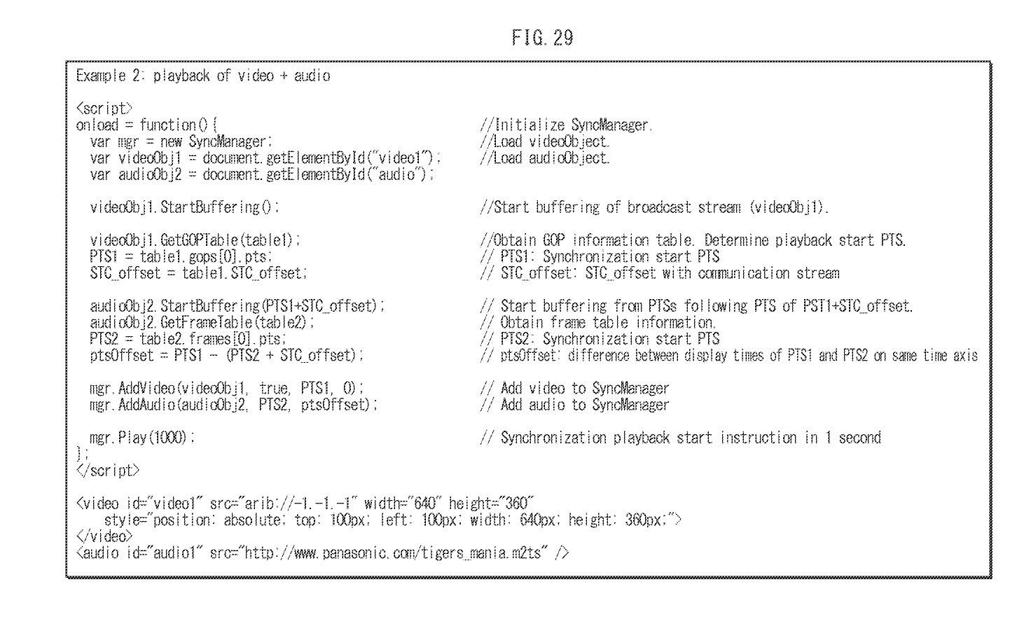

FIG. 29 illustrates an example of a script in HTML5 for content extension, particularly when performing synchronized playback of a broadcast stream (video stream+audio stream) and a communication stream (audio stream). In this case, the broadcast stream is specified by using a video tag, and the communication stream is specified by using an audio tag. Refer to the comments provided in FIG. 29 for explanation of Javascript operations.

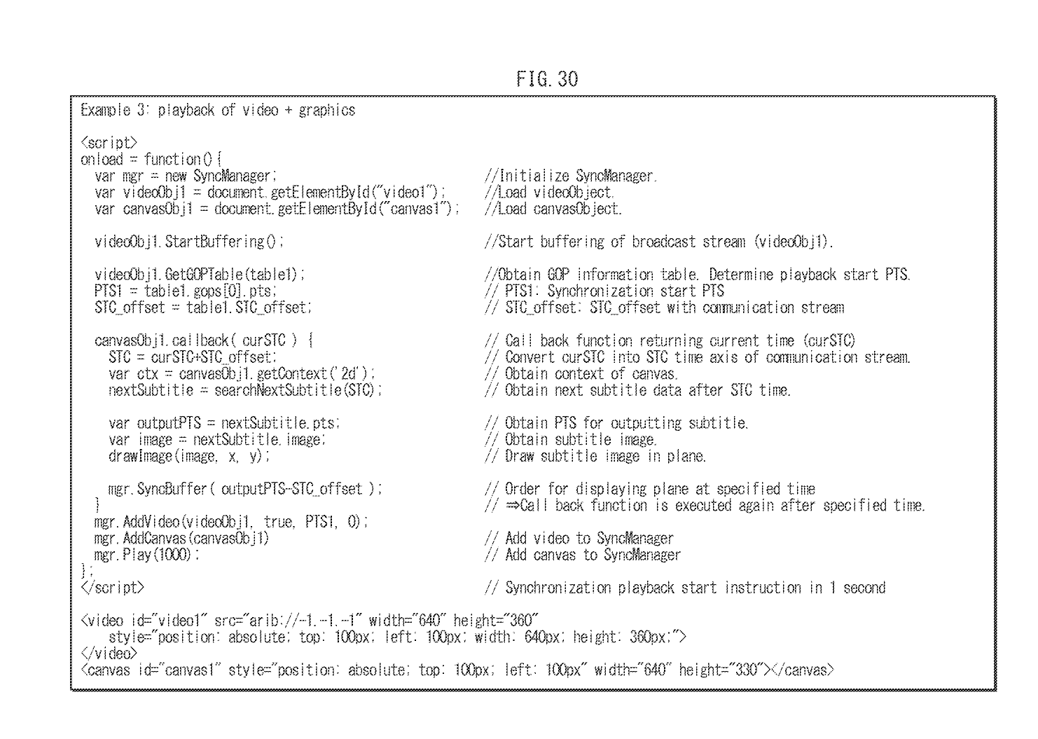

FIG. 30 illustrates an example of a script in HTML5 for content extension, particularly when performing synchronized playback of a broadcast stream (video stream+audio stream) and graphics data. In this case, a broadcast stream is specified by a video tag, and a graphics drawing area is specified by a canvas tag. Refer to the comments provided in FIG. 30 for explanation of Javascript operations.

In the present modification, description is provided of a method for realizing synchronized playback of a broadcast stream and a communication stream. However, the present invention is not limited to this, and needless to say, the present invention realizes synchronized playback of a broadcast stream and a broadcast stream, and synchronized playback of a communication stream and a communication stream by utilizing a similar structure and by merely altering input streams.

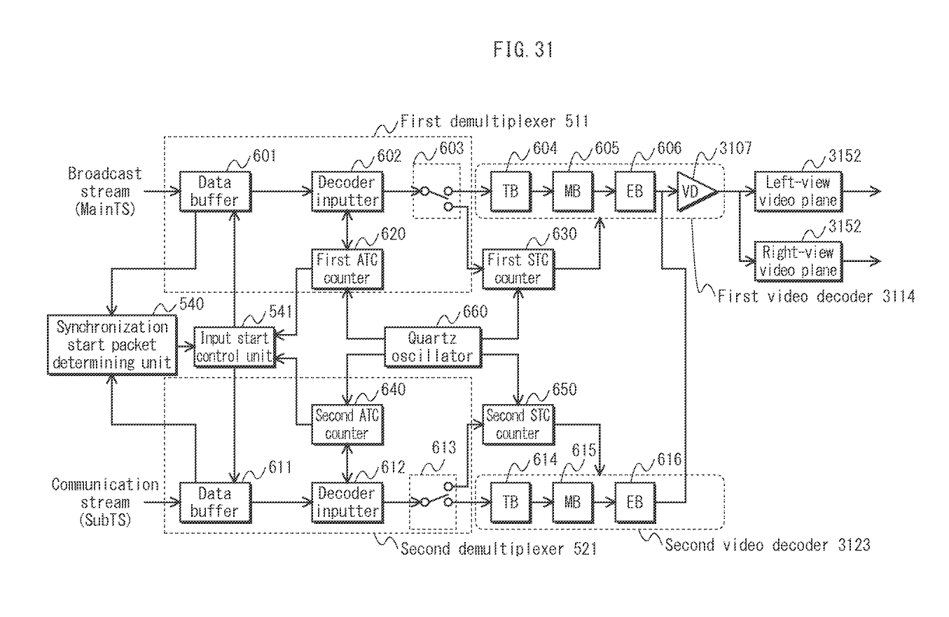

In the description of the primary stream decoding units for realizing synchronized playback illustrated in FIGS. 6, 10, 11, 12, and 14, description is provided that the video stream included in the broadcast stream and the video stream included in the communication stream have been separately compression-coded. However, the present invention is not limited to this, and needless to say, is applicable to a case where the communication stream contains a video stream that is compressed while referencing the video stream of the broadcast stream (i.e., inter-view reference). By making a modification as illustrated in FIG. 31, where the communication stream is output from the EB storing the communication stream and input to a decoder allocated to the broadcast stream at a DTS, the present invention realizes synchronized playback of the broadcast stream and a video stream that is compressed by utilizing, for example, inter-view reference.

### <Explanation of Technology Employed>

In the following, description is provided of technology that is employed in the embodiment and the modifications described above.

First, description is provided of the structure of a typical stream transmitted by digital television broadcasts and the like.

Digital television broadcasts and the like are transmitted using digital streams in the MPEG-2 TS format. The MPEG-2 TS format is a standard for multiplexing and transmitting various streams including audio and visual streams. In specific, the standard is specified by ISO/IEC13818-1 and ITU-T Recc. H222.0.

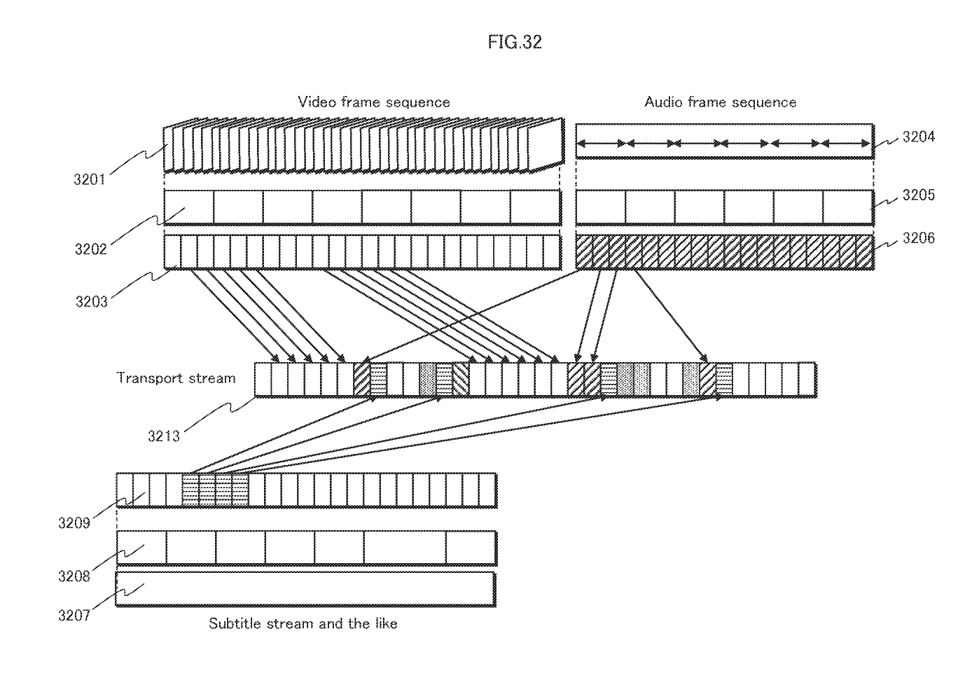

FIG. 32 illustrates the structure of a digital stream in the MPEG-2 TS format. As illustrated in FIG. 32, a digital stream in the MPEG-2 TS format is obtained by multiplexing a video stream, an audio stream, a subtitle stream and the like. A video stream contains the main video portion of a program, an audio stream contains the main audio, the sub-audio, etc., of the program, and a subtitle stream contains subtitle information of the program. A video stream is encoded and recorded according to a standard such as MPEG-2, MPEG-4 AVC, or similar. An audio stream is compressed, encoded and recorded according to a standard such as Dolby AC-3, MPEG-2 AAC, MPEG-4 AAC, HE-AAC, or similar.

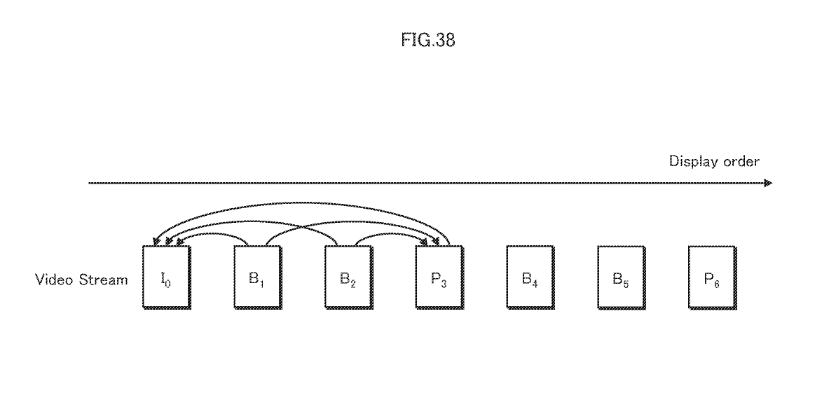

In the following, description is provided of the structure of a video stream. Video compression and encoding is performed under MPEG-2, MPEG-4 AVC, SMPTE VC-1, and so on by making use of spatial and temporal redundancies in the motion picture to compress the data amount thereof. One example of such a method that takes advantage of the temporal redundancies in the motion picture in the compression of data amount is the inter-picture predictive coding. According to the inter-picture predictive coding, a given picture is encoded by using, as a reference picture, another picture that is displayed earlier or later than the picture to be encoded. Further, detection is made of a motion amount from the reference picture, and difference values indicating the differences between the motion-compensated picture and the picture to be encoded are produced. Finally, by eliminating spatial redundancies from the differences so produced, compression of the amount of data is performed. FIG. 38 illustrates a reference structure between pictures in a typical video stream. An arrow extending from one picture indicates that the picture is compressed by referencing another picture to which the arrow extends.

In the following, a picture to which intra-picture coding is applied without the use of a reference picture and by using only the picture itself is referred to as an I-picture. Here, note that a picture is defined as a unit of encoding that encompasses both frames and fields. Also, a picture to which inter-picture coding is applied with reference to one previously-processed picture is referred to as a P-picture, a picture to which inter-picture coding is applied with reference to two previously-processed pictures at once is referred to as a B-picture, and a B-picture referenced by other pictures is referred to as a Br-picture. Furthermore, frames in a frame structure and fields in a field structure are referred to as video access units hereinafter.

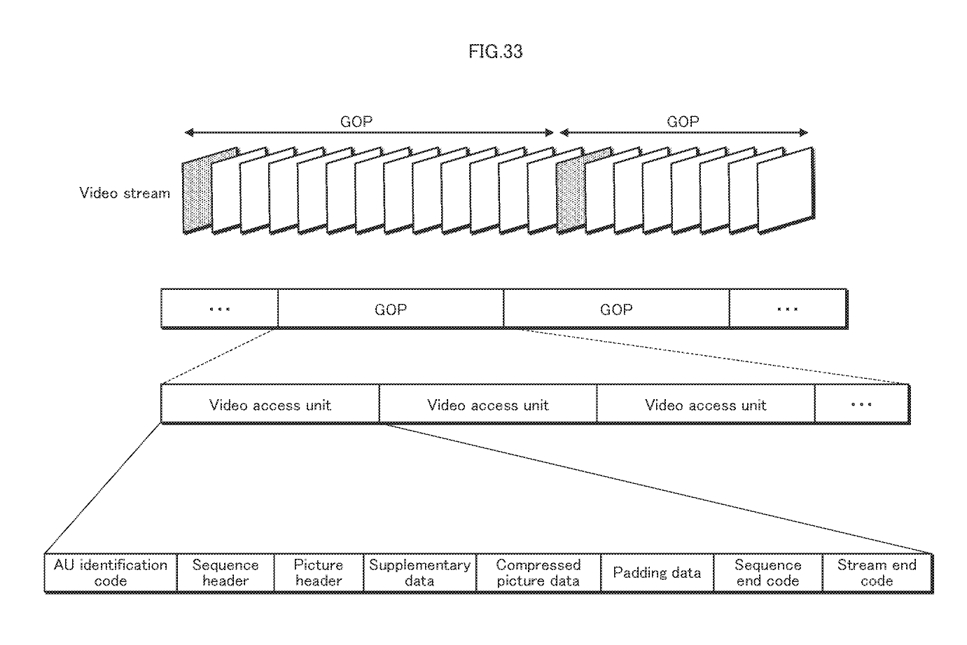

Further, a video stream has a hierarchical structure as illustrated in FIG. 33. More specifically, a video stream is made up of multiple groups of pictures (GOPs).

The GOPs are used as the basic unit of encoding, which enables motion picture editing and random access of the motion picture. A GOP is composed of one or more video access units. A video access unit is a unit containing encoded picture data, specifically a single frame in a frame structure and a single field in a field structure. Each video access unit is composed of an AU identification code, a sequence header, a picture header, supplementary data, compressed picture data, padding data, a sequence end code, a stream end code and the like. Under MPEG-4 AVC, all data is contained in units called NAL units.

The AU identification code is a start code indicating the start of an access unit. The sequence header is a header containing information common to all of the video access units that make up a playback sequence, such as the resolution, frame rate, aspect ratio, bitrate and the like. The picture header is a header containing information indicating an encoding format applied to the entire picture and the like. The supplementary data are additional data not required to decode the compressed data, such as closed-caption text information that can be displayed on a television simultaneously with the video and information about the structure of the GOP. The compressed picture data includes compression-coded picture data. The padding data are meaningless data that pad out the format. For example, the padding data may be used as stuffing data to maintain a fixed bitrate. The sequence end code is data indicating the end of a playback sequence. The stream end code is data indicating the end of a bit stream.

The internal configuration of the AU identification code, the sequence header, the picture header, the supplementary data, the compressed picture data, the padding data, the sequence end code, and the stream end code varies according to the video encoding method applied.

For example, under MPEG-4 AVC, the AU identification code is an access unit delimiter (AU delimiter), the sequence header is an sequence parameter set (SPS), the picture header is a picture parameter set (PPS), the compressed picture data consist of several slices, the supplementary data are Supplemental Enhancement Information (SEI), the padding data are filler data, the sequence end code corresponds to “End of Sequence”, and the stream end code corresponds to “End of Stream”.

For example, under MPEG-2, the sequence headers are sequence_Header, sequence_extension, and group_of_picture_header, the picture headers are picture_header and picture_coding_extension, the compressed picture data consist of several slices, the supplementary data are user_data, and the sequence end code corresponds to sequence_end_code. Although no AU identification code is present in this case, the end points of the access unit can be determined by using each of the header start codes.

In addition, not all data are required at all times. For instance, the sequence header is only needed for the first video access unit of a GOP, and may be omitted from other video access units. Further, depending on the encoding format, a given picture header may simply reference the previous video access unit in the order of encoding, without any picture headers being contained in the video access unit itself.

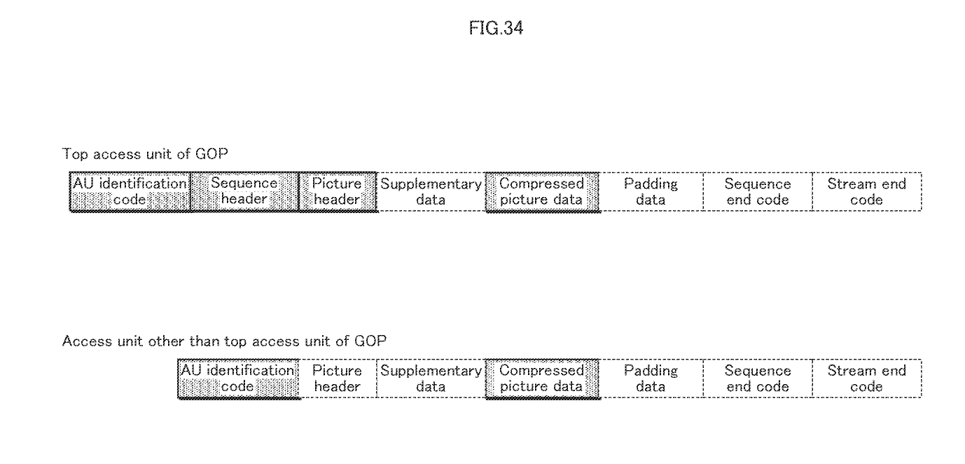

In addition, as illustrated in FIG. 34, the first video access unit of a GOP stores data of an I picture as the compressed picture data, always stores therein the AU identification code, the sequence header, the picture header, and the compressed picture data, and also stores the supplementary data, the padding data, the sequence end code, and the stream end code. Video access units other than the first video access unit of a GOP always stores the AU identification code and the compressed picture data, and also stores the supplementary data, the padding data, the sequence end code, and the stream end code.

Each of the streams multiplexed in a transport stream is identified by a stream ID called a PID. A demultiplexer can extract a given stream by extracting packets with the appropriate PID. The correlation between the PIDs and the streams is stored descriptors contained in a PMT packet, description on which is provided in the following.

FIG. 32 is a schematic diagram illustrating how a transport stream is multiplexed. First, a video stream 3201 composed of a plurality of video frames and an audio stream 3204 composed of a plurality of audio frames are respectively converted into PES packet sequences 3202 and 3205, and then converted into TS packets 3203 and 3206. Similarly, data of a subtitle stream 3207 are converted into a PES packet sequence 3208, and then further converted into TS packets 3209. An MPEG-2 transport stream 3213 is yielded by multiplexing these TS packets into a single stream.

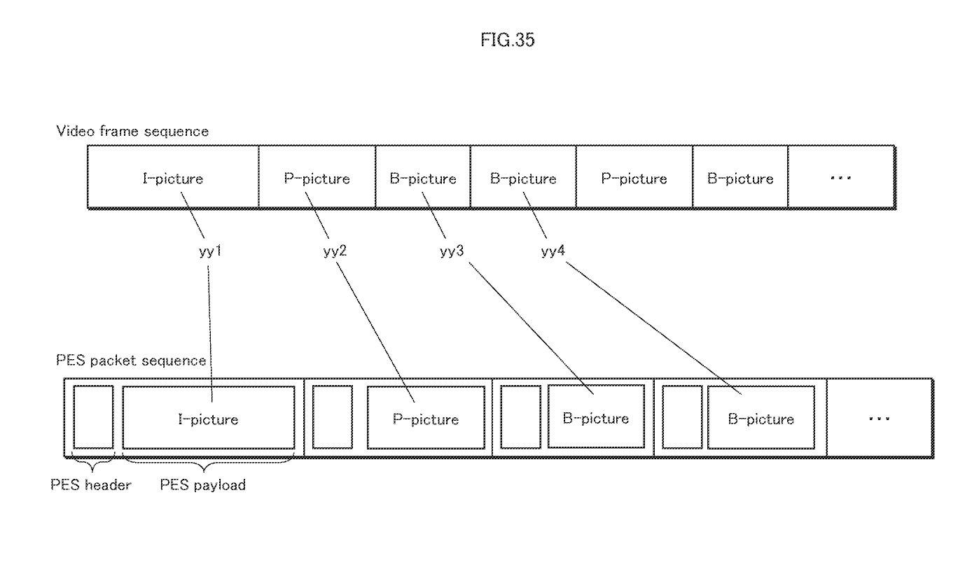

FIG. 35 illustrates further details of how a video stream is contained in a PES packet sequence. The top row of the figure shows a video frame sequence of a video stream. The second row shows a PES packet sequence. As shown by the arrows yy1, yy2, yy3, and yy4 in FIG. 35, the video presentation units of the video stream, namely the I-pictures, B-pictures, and P-pictures, are individually split and contained in the PES packets as the payloads thereof. Each PES packet has a PES header, and the PES header contains a presentation time stamp (PTS) indicating a display time of the corresponding picture, a decode time stamp (DTS) indicating a decoding time of the corresponding picture and the like.

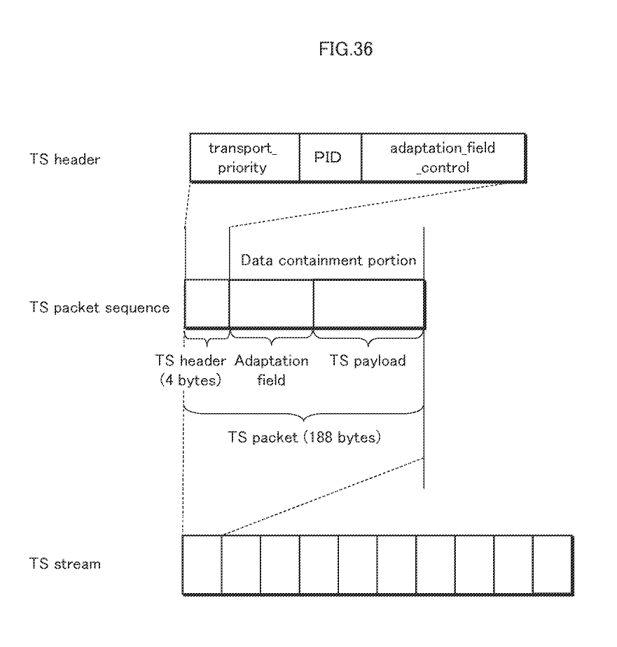

FIG. 36 illustrates the data structure of TS packets that compose a transport stream. A TS packet is a packet having a fixed-length of 188 bytes, and is composed of a 4-byte TS header, an adaptation field, and a TS payload. The TS header is composed of information such as transport_priority, PID, and adaptation_field_control. As previously mentioned, a PID is an ID identifying a stream that is multiplexed within the transport stream. The transport_priority is information identifying different types of packets among the TS packets having the same PID. The adaptation_field_control is information for controlling the configuration of the adaptation field and the TS payload. The adaptation_field_control indicates whether only one or both of the adaptation field and the TS payload are present, and if only one of the two is present, indicates which. In specific, the adaptation_field_control is set to 1 to indicate the presence of the TS payload only, is set to 2 to indicate the presence of the adaptation field only, and set to 3 to indicate the presence of both the TS payload and the adaptation field.

The adaptation field is an area for storing PCR and similar information, as well as stuffing data used to pad out the TS packet to 188 bytes. The PES packets are split and contained in the TS payload.

In addition to video, audio, subtitle, and other streams, the TS packets included in the transport stream can also be for a program association table (PAT), a program map table (PMT), a program clock reference (PCR) and the like. These packets are known as program specific information (PSI). The PAT indicates the PID of the PMT used within the transport stream. In addition, the PAT is registered with a PID of 0. The PMT includes the PIDs of each of the streams included in the transport stream, such as a video stream, an audio stream, and a subtitle stream, and also includes attribute information of each of the streams corresponding to the PIDs included therein. Further, the PMT also includes various descriptors pertaining to the transport stream. For instance, copy control information indicating whether or not an audio-visual stream may be copied is included among such descriptors. The PCR has system time clock (STC) information corresponding to the time at which the PCR packet is to be transferred to the decoder. This information enables synchronization between the decoder arrival time of the TS packet and the STC, which serves as the chronological axis for the PTS and DTS.

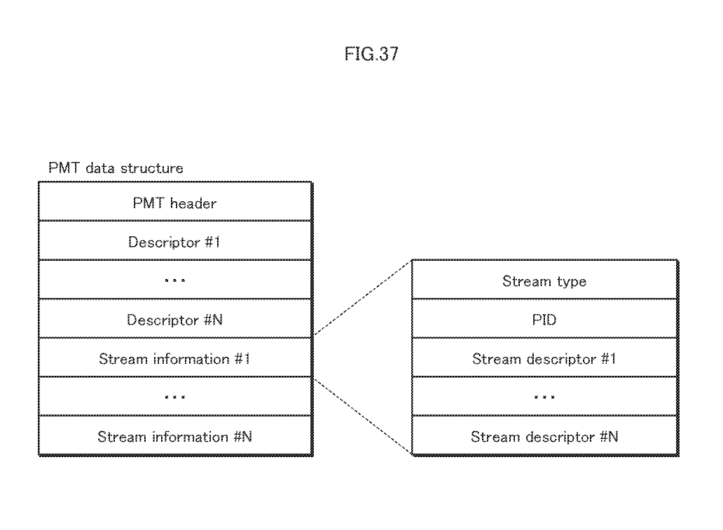

FIG. 37 illustrates the data structure of the PMT in detail. A PMT header containing such information as the length of the data included in the PMT is arranged at the head of the PMT. The PMT header is followed by several descriptors pertaining to the transport stream. The aforementioned copy control information and the like are written in such descriptors. The descriptors are followed by several pieces of stream information pertaining to each of the streams included in the transport stream. Each piece of stream information includes: a stream type; a stream PID; and stream descriptors including description of attribute information (such as a frame rate and an aspect ratio) of the corresponding stream. The stream type identifies the stream compression codec or the like of the stream.

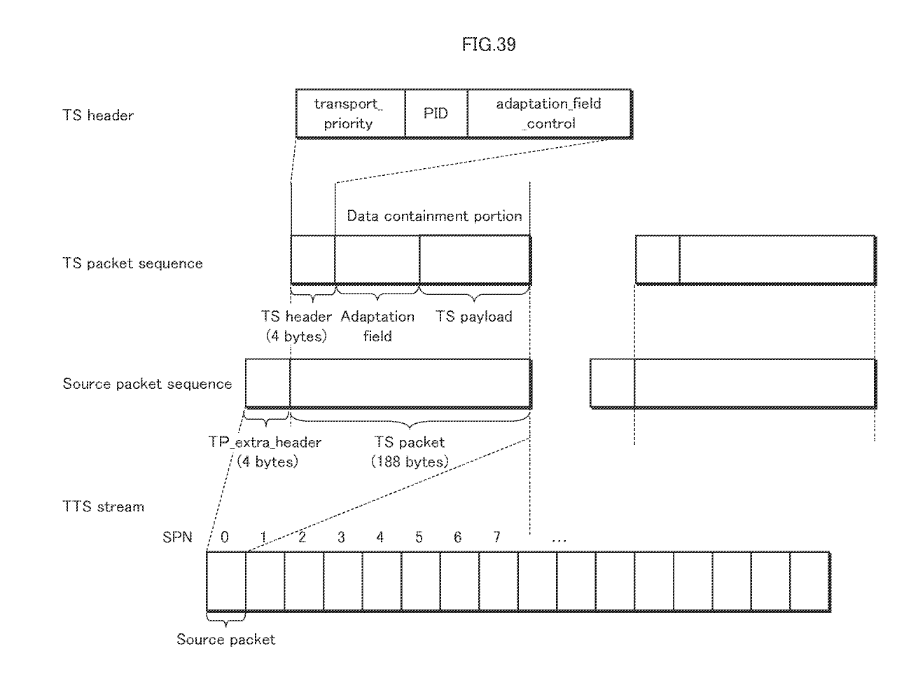

Here, the transport stream illustrated in the lowermost part of FIG. 36 is a stream including TS packets that are sequentially arranged. Streams used in broadcast waves typically have this format. Such a stream is hereinafter referred to as a TS stream. On the other hand, the transport stream illustrated in the lowermost part of FIG. 39 is a stream including source packets that are sequentially arranged. The source packets each include a 188-byte TS packet and a 4-byte time stamp appended to the head of the TS packet. Streams transmitted via communications typically have this structure. Such a stream is hereinafter referred to as a TTS stream. The time stamps appended to the head of each of the TS packets in the TTS stream are hereinafter referred to as “arrival_time_stamp”s (ATSs). An ATS indicates a time at which transfer of the TS packet to which the ATS is appended to the decoder is started. Further, since a TTS stream has a structure as illustrated in the lower portion of FIG. 14, where source packets are sequentially arranged, the number incremented from the top of the TTS stream is referred to as a source packet number (SPN).

A normal broadcast wave transmits a full TS, which is formed by multiplexing TSs for multiple channels. Specifically, a full TS is a TS stream that is composed of TS packet sequences each having a fixed length of 188 bytes. Meanwhile, when recording a broadcast program onto recording media such as a

BD-RE and an HDD, data for necessary channels are extracted from the full TS and are stored onto the recording media as partial TSs. A partial TS is a TTS stream. Here, when converting a TS stream into a TTS stream by simply removing unnecessary TS packets from the full TS and putting the remaining TS packets together, information indicating intervals between TS packets is lost. As such, the timing at which the TS packets are input to the decoder would differ from the timings intended upon transmission, and hence, the decoder would not be able to perform playback correctly. In view of this, so as to retain the information indicating the time intervals between TS packets in the full TS that have become unnecessary, appending of ATSs is performed. By making such a configuration and controlling the timings at which data are input to a decoder according to the ATSs, the decoder is able to perform playback without failure.

### <Supplement>

In the above, display devices pertaining to the embodiment and the modifications have been described as examples of implementation of the display device pertaining to the present invention. However and needless to say, the present invention is not limited to such display devices described in the embodiment and in the modifications, and can be modified as described in the following without departing from the spirit and scope of the present invention.

(1) The display device 110 in the embodiment is an example of a display device having a structure for receiving, via the internet communication network 140, communication video transmitted from the communication service providing station 130. However, the display device pertaining to the present invention is not necessarily limited to receiving communication video transmitted via the internet communication network 140. That is, it suffices that the display device pertaining to the present invention is provided with a structure for receiving a communication stream transmitted from the communication service providing station 130. For example, the display device pertaining to the present invention may receive communication video transmitted by the communication service providing station 130 via broadcast waves or via a dedicated line.

(2) The embodiment describes an example of a structure where the value of the STC_Offset stored in the PSI/SI of the broadcast stream is “0” when there is no need of correcting the display timing of the communication video. However, the present invention is not limited to such a structure, and as long as information indicating that there is no necessity of correcting the display timing of the communication video included in the communication stream can be included in the broadcast stream, other structures are similarly applicable. One example of such a structure is not storing the STC_Offset to the PSI/SI of the broadcast stream when it is not necessary to correct the display timing of the communication video included in the communication stream. When applying such a structure, the display device 110 performs processing similar to when the value of the STC_Offset is “0” when the STC_Offset is not stored in the PSI/SI of the broadcast stream received.

(3) In the embodiment, description is provided of an example where the broadcast stream and the communication stream are both stored in data buffers, with reference to FIG. 7A. However, the present invention is not limited to this, and when only the broadcast stream is stored in the data buffer, buffering may be started by (i) determining the synchronization start PTS of the communication stream based on the GOP table information of the broadcast wave and the STC_Offset of the broadcast wave and (ii) then making an inquiry to a server for data of the communication stream at the synchronization start PTS. Similarly, when only the broadcast stream is stored in the data buffer, buffering may be started by (i) determining the synchronization start PTS of the communication stream or the frame ID in the communication stream from which synchronized playback is to be started based on the GOP table information of the broadcast stream and the STC_Offset of the broadcast stream and (ii) then making an inquiry to a server for data of the communication stream at the synchronization start PTS.

(4) In the embodiment, a modification may be made of storing to the top video packet of each GOP, a PCR value of the packet as an adaptation field. By making such a modification, it would become no longer necessary to search for PCR packets near the video packet, and hence, the calculation of D1 and D2 is facilitated.

(5) In the embodiment, modification may be made such that the calculation of D1 and D2 is not performed by the display device and D1 and D2 are transmitted in the form of information on broadcast waves, in system packets of the communication stream, or in another video stream. Alternatively, modification may be made such that D1 and D2 are simply provided in the form of data from a server via communication.

(6) In modification 2, the communication stream may be an MP4 stream. However, since PTS and DTS are not appended to frames in an MP4 stream, management information indicating the PTS and DTS of each frame of the MP4 stream needs to be separately prepared in the MP4 header information. In such a case, processing is performed by using such timing information.

(7) In modification 4, description is provided of a structure that realizes synchronized playback by two different bodies. However, the present invention is not limited to this, and needless to say, by providing one or more additional stream decoding units, synchronized playback by three or more different bodies may be realized. Needless to say, the present invention realizes synchronized playback by a single body.

(8) In modification 7, even when frames of a given video stream are provided with frame IDs that are unique from the frame IDs that are provided to frames of a different video stream and thus, there is no relation between the frame IDs of different streams (i.e., when the same frame ID in a first stream and a second stream does not indicate a relationship such that synchronization is to be performed (such relation hereinafter referred to as a “synchronization relationship”)), the synchronization relationship between frames ID of the broadcast stream and frame IDs of the communication stream can be specifically defined by separately transmitting offset information indicating the synchronization relationship between the frame IDs.

(9) A part of or all of the information necessary for realizing the embodiment and the modifications, including the STC_Offset, the GOP information tables, the frame IDs, D1, D2, D3, and ATC_Offset, may be stored in the broadcast stream, the communication stream, or communication data acquirable from an application. Such information, when stored in a stream, is stored in the PSI/SI such as a PMT packet and an EIT packet, an event message in a BML packet, user data in each frame of video, etc. When such information is stored in video, the top frame of each GOP may collectively store information related to the frames included in the GOP or may only store information related to the top frame of the GOP.

(10) The present invention may be any combination of the embodiment and the modifications described above.

(11) In the following, description is provided on a structure of a display device pertaining to one aspect of the present invention, modifications thereof, and the effects achieved by the structure and the modifications.

(a) One aspect of the present invention is a display device that receives a stream containing a plurality of video frames, separately acquires and stores therein an image, and displays the received stream and the acquired image in synchronization. The display device comprises: a reception unit that receives a stream containing a plurality of video frames and first display timing information, the first display timing information specifying a display timing of each of the video frames; a display unit that displays each of the video frames at a corresponding display timing specified by the first display timing information; a storage unit that stores an image and second display timing information specifying a display timing of the image; and an acquisition unit that acquires correction information specifying a correction amount for correcting the display timing of the image and thereby enabling the image to be displayed in synchronization with the video frames displayed by the display unit. The display unit displays the image at a corrected display timing determined by correcting the display timing of the image by using the correction amount specified by the correction information, whereby the image is displayed in synchronization with the video frames.

The display device pertaining to one aspect of the present invention, having the structure as described above, is capable of displaying broadcast video and communication video in synchronization at the timing specified by the video content producer, even when a broadcast time of a program corresponding to the videos is changed after the display device receives and stores therein the communication video.

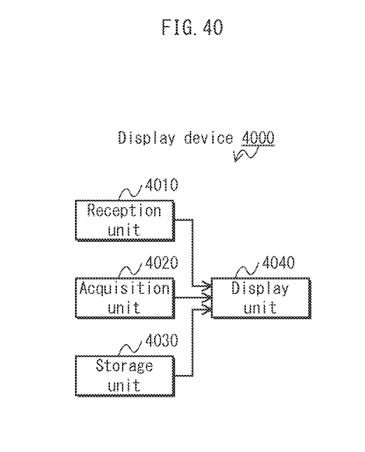

FIG. 40 is a diagram illustrating a structure of a display device 4000, which is one example of the display device pertaining to one aspect of the present invention.

As illustrated in FIG. 40, the display device 4000 includes: a reception unit 4010; a display unit 4020; a storage unit 4030; and an acquisition unit 4040.

The reception unit 4010 has the function of receiving a stream containing a plurality of video frames and first display timing information. The first display timing information specifies a display timing of each of the video frames. One example of implementation of the reception unit 4010 is the tuner 501 in the embodiment.

The display unit 4020 has the function of displaying each of the video frames included in the stream received by the reception unit 4010 at a corresponding display timing specified by the first display timing information included in the stream received by the reception unit 4010. One example of implementation of the display unit 4020 is a combination of the broadcast stream decoding unit 510, the communication stream decoding unit 520, the first video plane 552, the second video plane 555, the plane synthesizing processing unit 560, the display 580, and the input start control unit 541 in the embodiment.

The storage unit 4030 has the function of storing an image and second display timing information specifying a display timing of the image. One example of implementation of the storage unit 4030 is the buffer 542 in the embodiment.

The acquisition unit 4040 has the function of acquiring correction information specifying a correction amount for correcting the display timing of the image stored in the storage unit 4030 and thereby enabling the image stored in the storage unit 4030 to be displayed in synchronization with the video frames displayed by the display unit 4020. One example of implementation of the acquisition unit 4040 is the synchronization start packet determining unit 540 in the embodiment.

Further, the display unit 4020 has the function of displaying the image stored in the storage unit 4030 at a corrected display timing determined by correcting the display timing of the image stored in the storage unit 4030 by using the correction amount specified by the correction information acquired by the acquisition unit 4040.

(b) In the display device pertaining to one aspect of the present invention, the stream may further contain the correction information, and the acquisition unit may acquire the correction information from the stream.

By making such a modification, it becomes possible to acquire correction information from a stream received by the reception unit.

(c) In the display device pertaining to one aspect of the present invention, the display unit may comprise a display and display the video frames and the image on the display, and the display unit may superimpose the image onto each of the video frames when displaying the video frames and the image on the display.

By making such a modification, it becomes possible to superimpose an image stored in the storage unit onto each video frame received by the reception unit when displaying video frames received by the reception unit and an image stored in the storage unit.

(d) The display device pertaining to one aspect of the present invention may further comprise a sub-reception unit that receives a stream containing a plurality of video frames and information indicating a display timing. Further, in the display device pertaining to one aspect of the present invention, the storage unit may store the plurality of video frames received by the sub-reception unit as the image, and the storage unit may store the information received by the sub-reception unit as the second display timing information, the second display timing information thus specifying a display timing of each of the video frames received by the sub-reception unit.

By making such a modification, it becomes possible to display video received by the sub-reception unit in synchronization with video received by the reception unit.

(e) In the display device pertaining to one aspect of the present invention, the reception unit may comprise a broadcast wave reception unit that receives broadcast waves transmitted by a broadcast station for transmitting data, and the sub-reception unit may comprise a transmission signal reception unit that receives transmission signals transmitted from an external network for transmitting data, and the stream received by the reception unit may be a stream carried on the broadcast waves received by the broadcast wave reception unit, and the stream received by the sub-reception unit may be a stream carried on the transmission signals received by the transmission signal reception unit.

By making such a modification, it becomes possible to display video transmitted via a network in synchronization with video transmitted by broadcast waves.

(f) In the display device pertaining to one aspect of the present invention, the stream carried on the broadcast waves and the stream carried on the transmission signals may each be a stream in the Moving Picture Experts Group (MPEG)-2 transport stream (TS) format.

By making such a modification, it becomes possible to implement the reception unit and the sub-reception unit by applying a versatile method.

(g) The display device pertaining to one aspect of the present invention may further comprise a sub-reception unit that receives a stream containing a plurality of video frames and information indicating a display timing. Further, in the display device pertaining to one aspect of the present invention, the storage unit may store the plurality of video frames received by the sub-reception unit as the image, the storage unit may store the information received by the sub-reception unit as the second display timing information, the second display timing information thus specifying a display timing of each of the video frames received by the sub-reception unit, the stream received by the reception unit and the stream received by the sub-reception unit may each be a stream in the MPEG-2 TS format, the display unit may comprise: a first decoder that reconstructs a video frame from the stream received by the reception unit; a second decoder that reconstructs a video frame from the stream received by the sub-reception unit; a first arrival time counter that appends, to the stream received by the reception unit, information that indicates a first arrival time pertaining to a timing at which the stream received by the reception unit is to be input to the first decoder; a second arrival time counter that appends, to the stream received by the sub-reception unit, information that indicates a second arrival time pertaining to a timing at which the stream received by the sub-reception is to be input to the second decoder; and a delay input unit that, by using the first arrival time and the second arrival time, inputs the stream received by the sub-reception unit to the second decoder at a delayed timing that is later by a predetermined time period than a timing at which the stream received by the reception unit is input to the first decoder, and the second decoder may output the video frame reconstructed from the stream received by the sub-reception unit at an output timing such that the video frame reconstructed by the second decoder is displayed by the display unit at the corrected display timing.

By making such a modification, it becomes possible to display video received by the sub-reception unit in synchronization with video received by the reception unit.

(h) The display device pertaining to one aspect of the present invention may further comprise a multiplexer that generates a stream by multiplexing the video frame reconstructed by the first decoder and the video frame reconstructed by the second decoder.

By making such a modification, it becomes possible to generate a stream by multiplexing video received by the reception unit and video received by the sub-reception unit.

(i) The display device pertaining to one aspect of the present invention may further comprise a sub-reception unit that receives a stream containing a plurality of video frames and information indicating a display timing. Further, in the display device pertaining to one aspect of the present invention, the storage unit may store the plurality of video frames received by the sub-reception unit as the image, the storage unit may store the information received by the sub-reception unit as the second display timing information, the second display timing information thus specifying a display timing of each of the video frames received by the sub-reception unit, the stream received by the reception unit and the stream received by the sub-reception unit may each be a stream in the MPEG-2 TS format, the display unit may comprise: a first decoder that reconstructs a video frame from the stream received by the reception unit; a second decoder that reconstructs a video frame from the stream received by the sub-reception unit; an arrival time counter that appends, to the stream received by the reception unit, information that indicates a first arrival time pertaining to a timing at which the stream received by the reception unit is to be input to the first decoder, and appends, to the stream received by the sub-reception unit, information that indicates a second arrival time pertaining to a timing at which the stream received by the sub-reception is to be input to the second decoder; and a delay input unit that, by using the first arrival time and the second arrival time, inputs the stream received by the sub-reception unit to the second decoder at a delayed timing that is later by a predetermined time period than a timing at which the stream received by the reception unit is input to the first decoder, and the second decoder may output the video frame reconstructed from the stream received by the sub-reception unit at an output timing such that the video frame reconstructed by the second decoder is displayed by the display unit at the corrected display timing.

By making such a modification, it becomes possible to provide only one arrival time counter.

(j) The display device pertaining to one aspect of the present invention may further comprise a sub-reception unit that receives a stream containing a plurality of video frames and information indicating a display timing. Further, in the display device pertaining to one aspect of the present invention, the storage unit may store the plurality of video frames received by the sub-reception unit as the image, the storage unit may store the information received by the sub-reception unit as the second display timing information, the second display timing information thus specifying a display timing of each of the video frames received by the sub-reception unit, the stream received by the reception unit and the stream received by the sub-reception unit may each be a stream in the MPEG-2 TS format, the display unit may comprise: a first decoder that reconstructs a video frame from the stream received by the reception unit; and a second decoder that reconstructs a video frame from the stream received by the sub-reception unit, and the second decoder may output the video frame reconstructed from the stream received by the sub-reception unit at an output timing such that the video frame reconstructed by the second decoder is displayed by the display unit at the corrected display timing.

By making such a modification, it is possible to implement the reception unit by applying a versatile method.

(k) The display device pertaining to one aspect of the present invention may further comprise a sub-reception unit that receives a stream containing a plurality of video frames and information indicating a display timing. Further, in the display device pertaining to one aspect of the present invention, the storage unit may store the plurality of video frames received by the sub-reception unit as the image, the storage unit may store the information received by the sub-reception unit as the second display timing information, the second display timing information thus specifying a display timing of each of the video frames received by the sub-reception unit, the stream received by the reception unit and the stream received by the sub-reception unit may each be a stream in the MPEG-2 TS format, the display unit may comprise: a first decoder that reconstructs a video frame from the stream received by the reception unit; a second decoder that reconstructs a video frame from the stream received by the sub-reception unit; a first arrival time counter that appends, to the stream received by the reception unit, information that indicates a first arrival time pertaining to a timing at which the stream received by the reception unit is to be input to the first decoder; a second arrival time counter that appends, to the stream received by the sub-reception unit, information that indicates a second arrival time pertaining to a timing at which the stream received by the sub-reception is to be input to the second decoder; and a delay input unit that, by using the first arrival time and the second arrival time, inputs the stream received by the sub-reception unit to the second decoder at a delayed timing that is later by a predetermined time period than a timing at which the stream received by the reception unit is input to the first decoder, and the second decoder may output the video frame reconstructed from the stream received by the sub-reception unit at an output timing such that the video frame reconstructed by the second decoder is displayed by the display unit at the corrected display timing, the second decoder may output the video frame reconstructed from the stream received by the sub-reception unit at the output timing by using (i) the correction amount, (ii) a first reference time axis time, on a reference time axis, corresponding to the first arrival time, and (iii) a second reference time axis time, on the reference time axis, corresponding to the second arrival time.

By making such a modification, it becomes possible to display video received by the sub-reception unit in synchronization with video received by the reception unit by using a reference time axis.

(l) In the display device pertaining to one aspect of the present invention, the image may be a computer graphics image, and the display unit may comprise: a decoder that reconstructs video frames from the stream; and an image output unit that outputs the computer graphics image at an output timing such that the computer graphics image is displayed by the display unit at the corrected display timing.

By making such a modification, it becomes possible to display a computer graphics image in synchronization with video received by the reception unit.

Another aspect of the present invention is a transmission device comprising: a video storage unit that stores a plurality of video frames; a generation unit that generates a stream by multiplexing: the video frames stored in the video storage unit; first display timing information specifying a display timing of each of video frames; and correction information specifying a correction amount for causing an external device, storing second display timing information specifying a display timing of an image, to correct the display timing of the image and thereby display the image at a corrected display timing so as to be displayed in synchronization with the video frames, the corrected display timing determined by correcting the display timing of the image by using the correction amount specified by the correction information; and a transmission unit that transmits the stream to the external device.

The transmission device pertaining to one aspect of the present invention is capable of multiplexing a plurality of video frames, first display timing information, and correction information and transmitting the result of the multiplexing.

### INDUSTRIAL APPLICABILITY

The present invention is widely applicable to devices that play back broadcast content and content accompanying the broadcast content in synchronization.

### REFERENCE SIGNS LIST

501 tuner

502 communication interface

510 broadcast stream decoding unit

511 first demultiplexer

512 first audio decoder

513 subtitle decoder

514 first video decoder

515 system packet manager

520 communication stream decoding unit

521 second demultiplexer

523 second video decoder

522 second audio decoder

530 application execution control unit

540 synchronization start packet determining unit

541 input start control unit

552 first video plane

554 graphics plane

555 second video plane

560 plane synthesizing processing unit

1. A display device that receives a stream containing a plurality of video frames, separately acquires and stores therein an image, and displays the received stream and the acquired image in synchronization, the display device comprising:
a reception unit that receives a stream containing a plurality of video frames and first display timing information, the first display timing information specifying a display timing of each of the video frames;
a display unit that displays each of the video frames at a corresponding display timing specified by the first display timing information;
a storage unit that stores an image and second display timing information specifying a display timing of the image; and
an acquisition unit that acquires correction information specifying a correction amount for correcting the display timing of the image and thereby enabling the image to be displayed in synchronization with the video frames displayed by the display unit, wherein
the display unit displays the image at a corrected display timing determined by correcting the display timing of the image by using the correction amount specified by the correction information, whereby the image is displayed in synchronization with the video frames.

2. The display device of claim 1, wherein
the stream further contains the correction information, and
the acquisition unit acquires the correction information from the stream.

3. The display device of claim 2, wherein
the display unit comprises a display and displays the video frames and the image on the display, and
the display unit superimposes the image onto each of the video frames when displaying the video frames and the image on the display.

4. The display device of claim 3 further comprising
a sub-reception unit that receives a stream containing a plurality of video frames and information indicating a display timing, wherein
the storage unit stores the plurality of video frames received by the sub-reception unit as the image, and
the storage unit stores the information received by the sub-reception unit as the second display timing information, the second display timing information thus specifying a display timing of each of the video frames received by the sub-reception unit.

5. The display device of claim 4, wherein
the reception unit comprises a broadcast wave reception unit that receives broadcast waves transmitted by a broadcast station for transmitting data, and the sub-reception unit comprises a transmission signal reception unit that receives transmission signals transmitted from an external network for transmitting data, and
the stream received by the reception unit is a stream carried on the broadcast waves received by the broadcast wave reception unit, and the stream received by the sub-reception unit is a stream carried on the transmission signals received by the transmission signal reception unit.

6. The display device of claim 5, wherein
the stream carried on the broadcast waves and the stream carried on the transmission signals are each a stream in the Moving Picture Experts Group (MPEG)-2 transport stream (TS) format.

7. The display device of claim 1 further comprising
a sub-reception unit that receives a stream containing a plurality of video frames and information indicating a display timing, wherein
the storage unit stores the plurality of video frames received by the sub-reception unit as the image,
the storage unit stores the information received by the sub-reception unit as the second display timing information, the second display timing information thus specifying a display timing of each of the video frames received by the sub-reception unit,
the stream received by the reception unit and the stream received by the sub-reception unit are each a stream in the MPEG-2 TS format,
the display unit comprises:
a first decoder that reconstructs a video frame from the stream received by the reception unit;
a second decoder that reconstructs a video frame from the stream received by the sub-reception unit;
a first arrival time counter that appends, to the stream received by the reception unit, information that indicates a first arrival time pertaining to a timing at which the stream received by the reception unit is to be input to the first decoder;
a second arrival time counter that appends, to the stream received by the sub-reception unit, information that indicates a second arrival time pertaining to a timing at which the stream received by the sub-reception is to be input to the second decoder; and
a delay input unit that, by using the first arrival time and the second arrival time, inputs the stream received by the sub-reception unit to the second decoder at a delayed timing that is later by a predetermined time period than a timing at which the stream received by the reception unit is input to the first decoder, and
the second decoder outputs the video frame reconstructed from the stream received by the sub-reception unit at an output timing such that the video frame reconstructed by the second decoder is displayed by the display unit at the corrected display timing.

8. The display device of claim 7 further comprising
a multiplexer that generates a stream by multiplexing the video frame reconstructed by the first decoder and the video frame reconstructed by the second decoder.

9. The display device of claim 1 further comprising
a sub-reception unit that receives a stream containing a plurality of video frames and information indicating a display timing, wherein
the storage unit stores the plurality of video frames received by the sub-reception unit as the image,
the storage unit stores the information received by the sub-reception unit as the second display timing information, the second display timing information thus specifying a display timing of each of the video frames received by the sub-reception unit,
the stream received by the reception unit and the stream received by the sub-reception unit are each a stream in the MPEG-2 TS format,
the display unit comprises:
a first decoder that reconstructs a video frame from the stream received by the reception unit;
a second decoder that reconstructs a video frame from the stream received by the sub-reception unit;
an arrival time counter that appends, to the stream received by the reception unit, information that indicates a first arrival time pertaining to a timing at which the stream received by the reception unit is to be input to the first decoder, and appends, to the stream received by the sub-reception unit, information that indicates a second arrival time pertaining to a timing at which the stream received by the sub-reception is to be input to the second decoder; and
a delay input unit that, by using the first arrival time and the second arrival time, inputs the stream received by the sub-reception unit to the second decoder at a delayed timing that is later by a predetermined time period than a timing at which the stream received by the reception unit is input to the first decoder, and
the second decoder outputs the video frame reconstructed from the stream received by the sub-reception unit at an output timing such that the video frame reconstructed by the second decoder is displayed by the display unit at the corrected display timing.

10. The display device of claim 1 further comprising
a sub-reception unit that receives a stream containing a plurality of video frames and information indicating a display timing, wherein
the storage unit stores the plurality of video frames received by the sub-reception unit as the image,
the storage unit stores the information received by the sub-reception unit as the second display timing information, the second display timing information thus specifying a display timing of each of the video frames received by the sub-reception unit,
the stream received by the reception unit and the stream received by the sub-reception unit are each a stream in the MPEG-2 TS format,
the display unit comprises:
a first decoder that reconstructs a video frame from the stream received by the reception unit; and
a second decoder that reconstructs a video frame from the stream received by the sub-reception unit, and
the second decoder outputs the video frame reconstructed from the stream received by the sub-reception unit at an output timing such that the video frame reconstructed by the second decoder is displayed by the display unit at the corrected display timing.

11. The display device of claim 1 further comprising
a sub-reception unit that receives a stream containing a plurality of video frames and information indicating a display timing, wherein
the storage unit stores the plurality of video frames received by the sub-reception unit as the image,
the storage unit stores the information received by the sub-reception unit as the second display timing information, the second display timing information thus specifying a display timing of each of the video frames received by the sub-reception unit,
the stream received by the reception unit and the stream received by the sub-reception unit are each a stream in the MPEG-2 TS format,
the display unit comprises:
a first decoder that reconstructs a video frame from the stream received by the reception unit;
a second decoder that reconstructs a video frame from the stream received by the sub-reception unit;
a first arrival time counter that appends, to the stream received by the reception unit, information that indicates a first arrival time pertaining to a timing at which the stream received by the reception unit is to be input to the first decoder;
a second arrival time counter that appends, to the stream received by the sub-reception unit, information that indicates a second arrival time pertaining to a timing at which the stream received by the sub-reception is to be input to the second decoder; and
a delay input unit that, by using the first arrival time and the second arrival time, inputs the stream received by the sub-reception unit to the second decoder at a delayed timing that is later by a predetermined time period than a timing at which the stream received by the reception unit is input to the first decoder, and
the second decoder outputs the video frame reconstructed from the stream received by the sub-reception unit at an output timing such that the video frame reconstructed by the second decoder is displayed by the display unit at the corrected display timing, the second decoder outputs the video frame reconstructed from the stream received by the sub-reception unit at the output timing by using (i) the correction amount, (ii) a first reference time axis time, on a reference time axis, corresponding to the first arrival time, and (iii) a second reference time axis time, on the reference time axis, corresponding to the second arrival time.

12. The display device of claim 1, wherein
the image is a computer graphics image, and
the display unit comprises:
a decoder that reconstructs video frames from the stream; and
an image output unit that outputs the computer graphics image at an output timing such that the computer graphics image is displayed by the display unit at the corrected display timing.

13. A transmission device comprising:
a video storage unit that stores a plurality of video frames;
a generation unit that generates a stream by multiplexing:
the video frames stored in the video storage unit;
first display timing information specifying a display timing of each of video frames; and
correction information specifying a correction amount for causing an external device, storing second display timing information specifying a display timing of an image, to correct the display timing of the image and thereby display the image at a corrected display timing so as to be displayed in synchronization with the video frames, the corrected display timing determined by correcting the display timing of the image by using the correction amount specified by the correction information; and
a transmission unit that transmits the stream to the external device.
